(19) United States
(12) Patent Application Publication
(10) Pub. No.: US 2011/0022346 A1
(43) Pub. Date: Jan. 27, 2011

(54) CONTROLLER AND METHOD FOR IMPROVING THE EFFICIENCY OF HEATING AND COOLING SYSTEMS

(76) Inventors: Todd M. ROSSI, Princeton, NJ (US); Keith A. Temple, South Canaan, PA (US)

Correspondence Address: BLANK ROME LLP, WATERGATE, 600 NEW HAMPSHIRE AVENUE, N.W., WASHINGTON, DC, 20037, US

(21) Appl. No.: 12/711,105

(22) Filed: Feb. 23, 2010

Related U.S. Application Data
(60) Provisional application No. 61/154,646, filed on Feb. 23, 2009.

(51) Int. Cl. G06F 15/00; G01K 13/00; G01L 9/00

(52) U.S. Cl. 702/130; 702/182; 702/138

(57) ABSTRACT

A computerized hardware and software system and a method for processing and storing measured data from various inputs (sensors) that reduces the data memory requirements and data transmission requirements of heating, ventilation, air conditioning, and/or refrigeration systems (HVAC&R) by creating a more compact data structure that retains data resolution, as required, based on the intended use of the measured data. The system and method are especially applicable to data processing and storage associated with the monitoring of such thermal equipment and systems but may be used in other data collection of other types of systems where system performance monitoring is desired.

### CROSS-REFERENCE TO RELATED APPLICATIONS

This application is related to U.S. Provisional Application Ser. No. 61/154,646, filed Feb. 23, 2009, the content of which is incorporated herein by reference.

### BACKGROUND OF THE INVENTION

1. Field of the Invention

The present invention is related to improving the efficiency of heating, ventilation, air conditioning, and refrigeration systems, and in particular, to controllers and methods for collecting information about such systems to improve their efficiency and for other purposes.

2. Description of the Related Art

It is well established that trend logging is the most common approach to data collection. The techniques more commonly used involve collecting and storing data at pre-defined time intervals, which is also referred to as time-based data logging. The data record stored using this technique may represent an average value when the data are sampled at one frequency and stored at a lower frequency (i.e., because more measured values will be available than the number of values actually stored in memory). The memory devices of such systems usually allocate memory for each data record so as to store each measured parameter as a real number. This is an effective method for data collection and storage when time is primary an independent variable. However, in cases were time is not the main independent variable, such techniques result in inefficient use of memory for storing data.

Accordingly, what is needed is an apparatus and methods for collecting and processing measured data in a way that is different from the common trend logging approach. What is needed is an apparatus and method for improving the collection and storage of measured data by reducing the amount of stored data in memory that is not important or provides less important information about a system so that more, better quality, more informative, and more robust operating parameter information is communicated to a user or control device and in a shorter period of time. This can improve the system performance and efficiency by better monitoring the system as it operates in real-time.

### BRIEF SUMMARY OF THE INVENTION

The present invention relates to computerized hardware and software and a method of processing and storing measured data from various inputs (sensors) that reduces the data memory requirements and data transmission requirements of heating, ventilation, air conditioning, and/or refrigeration systems (HVAC&R) by creating a more compact data structure that retains data resolution, as required, based on the intended use of the measured data. The apparatus and method is especially applicable to data processing and storage associated with the monitoring of such thermal equipment and systems but may be used in other data collection of other types of systems where system performance monitoring is desired.

The method of the present invention is appropriate for data processing and storage when time is not the primary independent variable. The method focuses on retaining the relationship between key independent variables and the relevant dependent parameters. Data are processed and stored in a manner that captures variations in the independent variables that drive variations in the independent variables, while filtering variations that are primarily time-based such as startup transients, damper movements, valve movements, etc. This is essentially filtering out transient data to reduced the data set to one consisting of quasi-steady data. The data processing is then focused on retaining the relationships between independent variables and dependent parameters that are associated with the measured data.

In one aspect of the present invention, a bin approach has been developed that reduces the measured data set while maintaining the aforementioned close relationships. Bins are defined based on ranges of each variable or parameter and the combinations thereof. A time scale is defined for occurrences (e.g., one minute) and then occurrences are tabulated for each bin for a longer time scale (e.g., one day). The data record identifies a stamp (e.g., the day), the bin ID, and the number of occurrences. When various bin structures are used for different types of data, the record will also require a data type ID. The data bin concept is described in more detail below. Additional aspects of the method of the present invention are discussed below.

The data processing and storage methods according to the present invention have the following potential advantages and features:
1. Reduces memory requirement for data storage and transmission by avoiding memory allocation required to save real numbers;
2. Tuned data resolution (adjust bin widths) based on data characteristics, i.e., high resolution in range where required (frequent or important occurrences) and low resolution where appropriate;
3. Stores data in a form of performance parameters required for diagnostics, performance evaluation, etc. instead of storing all measured values;
4. Bins one or more dependent parameters together with independent variables to retain relationships between data;
5. Filters data to retain data only for certain operating conditions (i.e., quasi steady-state versus transient, system on, etc.);
6. Groups data by operating modes (i.e., fan on/off, occupied/unoccupied, peak/non-peak electric rate, etc.) to account for time-related operation characteristics;
7. Reduces data by discarding bin records deemed unimportant due to limited occurrences or unimportant range of parameters;
8. Collapses old data to longer time scales; for example: the most recent data is stored as bin occurrences for each day, data older than 1 year is collapsed to bin occurrences for each week, data older than 2 years is collapsed to bin occurrences for each month.

The data processing and storage methods according to the present invention have the following potential disadvantages, which may be addressed by the inclusion of additional software and hardware, as needed, in the present invention:
1. Does not capture (discards) sequence of events (startup transients, etc.);
2. Requires some understanding of system performance to define appropriate bin structure before collecting data.

The system and method for processing and storing measured data is based on identifying key performance parameters of the HVAC&R system that are determined from measured data, and then sorting the data into predefined data bins and storing the data based on that bin structure. The width of bins for each parameter is variable and is defined based on the desired data resolution over ranges of the parameter. Parameters that are correlated are binned as a group to retain relationships between independent and dependent parameters. The stored data represents occurrences of binned performance parameters that are calculated values and/or directly measured values.

It is a principal object of the present invention to provide a system and method for accumulating data for the evaluation of steady-state unit performance and to make the data available as read-only values over a BACnet network.

It is another object of the present invention to use a communications device for retrieving the data by a service technician or over a communications network.

It is still another object of the present invention to filter out transient data to reduced dat sets to ones consisting only or primarily of quasi-steady data.

It is another object of the present invention to use bin structures based on pre-defined ranges of each operating parameter of interest.

It is still another object of the invention to measure operating parameters such as temperature, pressure, or status.

Those and other objects and advantages of the present invention are accomplished, as fully described herein, by an apparatus for evaluating the performance and efficiency of a steady-state system by providing information over a communications network, the system having at least one sensor for providing an output corresponding to at least one measurable operating parameter; a signal conditioning and converter circuit for processing the output; a microprocessor for assigning at least some of the data into at least one pre-determined bin, wherein the bin is used for minimizing the amount of memory space for storing the output in a memory device; and a communications network for transmitting the bin information for subsequent evaluation.

The objects and advantages of the present invention are also accomplished, as fully described herein, by a method for receiving, storing, and providing system data for evaluating a steady-state performance of the system, the method involving providing at least one sensor in an operating heating, ventilation, air conditioning or refrigeration system, the system having at least one cycle; sampling real-time data at a predefined frequency using the at least one sensor; computing average values for the real-time data for a predefined time interval; calculating one or more cycle parameters using the real-time data or the average values; writing the calculated cycle parameters or the average values as a first data bin record set to a memory storage device; calculating one or more E/C performance parameters for each of a data bin record set for the at least one cycle; writing the E/C performance parameters as a second data bin record set to the memory storage device; processing the first and second data bin record sets to identify a steady-state refrigeration data set; calculating one or more refrigeration parameters for each of a steady-state refrigeration data set for the cycle; writing the refrigeration parameters as a third data bin record set to the memory storage device; and providing one or a combination of the first, second, and third data bin record sets over a communications network for evaluating the performance and increasing the efficiency of the system.

### BRIEF DESCRIPTION OF THE DRAWINGS

FIG. 1 is a schematic block diagram showing a configuration of a data processing module according to one aspect of the present invention;

FIGS. 2A and 2B are general process flow diagrams of one embodiment of the invention suitable where data logging is useful or desirable;

FIG. 3 is a graph of a cooling cycle load defined by a thermostat call for cooling of an air conditioning device between ON and OFF loads according to one embodiment of the invention;

FIG. 4 is a process flow diagram for a mixed air calculation according to one embodiment of the present invention; and

FIGS. 5A through 5D are general process flow diagrams of another embodiment of the invention.

### DETAILED DESCRIPTION OF THE INVENTION

Several preferred embodiments of the invention are described for illustrative purposes, it being understood that the invention may be embodied in other forms not specifically shown in the drawings. The figures will be described with respect to the system architecture and methods for using the system to achieve one or more of the objects of the invention and/or receive the benefits derived from the advantages of the invention as set forth above.

It is to be understood that the present invention may be implemented in various forms. For example, the invention may be embodied in hardware, software, firmware, special purpose computing devices, or a combination thereof, that may be integrally part of or separate from but operatively (i.e., electrically and physically) connected to an HVAC&R or other type of system.

The present invention may be implemented in software as a program tangibly embodied on a program storage device. The program may be uploaded to, and executed by, a computing machine comprising any suitable computing architecture, either centrally executed or executed on distributed devices networked to each other.

Preferably, the machine executing the aforementioned program is implemented on a computer having hardware including one or more central processing units (CPU); one or more memory devices, such as a random access memory or programmable read only memory (RAM/PROM); and one or more input/output (I/O) interface devices, such as peripheral device interfaces. The computer may also include an operating system and microinstruction code. The various processes and functions of the software described herein may either be part of the microinstruction code or part of the program (or a combination thereof), which is executed via the operating system.

In addition, various other peripheral devices may be connected or networked to the computer such as additional data storage devices, printing devices, data loggers, and various sensor (described below).

It is to be further understood that, because some of the constituent system components and method steps depicted in the accompanying figures are preferably implemented in software, the actual connections between the system components (or the process steps) may differ depending upon the manner in which the present invention is executed by the program(s).

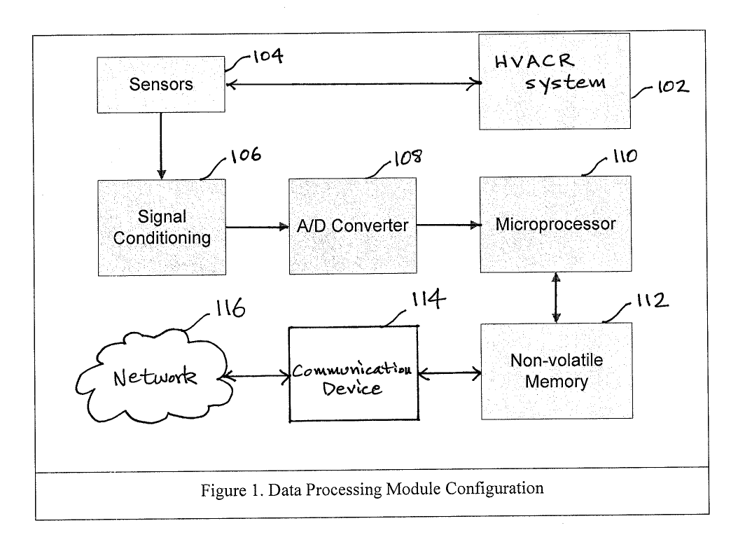

Turning first to FIG. 1, shown therein is a schematic block diagram showing a configuration of a data processing module and communications system according to one aspect of the present invention. In the figure, an HVAC&R system 102 is shown. Although an HVAC&R system is used to illustrate the present invention, it may also be implemented in other kinds of systems.

The HVAC&R system 102 is equipped with or can accept various sensors 104 that monitor the same or different operating parameters of the HVAC&R system 102, such as the operating parameters of a compressor and fan (not shown). The sensors 104 may be used to monitor various parameters such as, but not limited to, superheat (SH) temperature, outdoor air temperature (OAT), thermostat position, return air temperature (RAT), mixed air temperature (MAT), supply air temperature (SAT), outdoor air humidity (OAH), return air humidity (RAH), indoor airflow status, return air enthalpy (RAE), mechanical cooling status, economizer cooling status, heating status, suction temperature, suction pressure, and others (listed and discussed below).

The outputs of the various sensors 104 (i.e., in the form of electrical signals) are processed by signal conditioning circuits 106 and analog to digital (A/D) converter circuits 108. Program code stored in memory or read into memory (not shown) and executed by a microprocessor 110 takes the signals from the analog to digital (A/D) converter circuits 108 and stores the processed signals in a non-volatile memory device 112. A communications device 114 is used to retrieve and transmit the information stored in the non-volatile memory device 112 and receive data and instructions from an external device. For example, a separate device, such as a portable handheld device or remote computing device in data communication with the non-volatile memory device 112, may be used to read the stored signal data from the non-volatile memory device 112. The portable device may be carried by a technician to the HVAC&R system, for example. The remote computing device may connected by way of a communications network 116 like the Internet or, more specifically, a network built according to the BACnet protocol (American Society of Heating, Refrigeration and Air-Conditioning Engineers (ASHRAE)).

The aforementioned data bin system and method can be understood by reference to a specific prospective or hypothetical examples illustrating one embodiment of the present invention.

Table 1 shows one dependent parameter (i.e., superheat of a refrigeration cycle used for air-conditioning), and one independent parameter (i.e., outdoor air temperature). The SH values would most likely be calculated from several measurements (e.g., suction temperature and suction pressure) obtained by one or more of the sensors 104, while the OAT would be measured directly with another one or more of the sensors 104. In this relatively simple example, four bins are used for each of the two parameters (SH and OAT) for a total of 16 bins for the data sets as shown in Table 1.

TABLE 1
Example Bin Structure for SH and OAT Data.

| Bin | | Outdoor Air |
|---|---|---|
| ID | Superheat (° F.) | Temperature (° F.) |
| 0000 | 0 to 10 | <75 |
| 0001 | 0 to 10 | 75 to 85 |
| 0010 | 0 to 10 | 85 to 95 |
| 0011 | 0 to 10 | >95 |
| 0100 | 10 to 20 | <75 |
| 0101 | 10 to 20 | 75 to 85 |
| 0110 | 10 to 20 | 85 to 95 |
| 0111 | 10 to 20 | >95 |
| 1000 | 20 to 30 | <75 |
| 1001 | 20 to 30 | 75 to 85 |
| 1010 | 20 to 30 | 85 to 95 |
| 1011 | 20 to 30 | >95 |
| 1100 | >30 | <75 |
| 1101 | >30 | 75 to 85 |
| 1110 | >30 | 85 to 95 |
| 1111 | >30 | >95 |

Example measurements derived from the sensors 104 are presented in Table 2 with the corresponding bin designation based on the scheme shown in Table 1.

TABLE 2
Example Bin Data for SH and OAT data.

| | Outdoor Air | Bin |
|---|---|---|
| Superheat (° F.) | Temperature (° F.) | ID |
| 24.2 | 74.5 | 1000 |
| 19.5 | 83.1 | 0101 |
| 15.1 | 90.7 | 0110 |
| 7.4 | 97.0 | 0111 |

An example of a data bin structure is presented in Table 3 for one dependent parameter (i.e., superheat of a refrigeration cycle used for air-conditioning), with one independent parameter (i.e., outdoor air temperature). For this example, the SH has a range from 0° F. to a typical maximum of approximately 50° F.

TABLE 3
Example Bin Structure for SH and OAT Data.

| | | Outdoor Air |
|---|---|---|
| Bin | Superheat (° F.) | Temperature (° F.) |
| 0 | 0 to 2 | <50 |
| 1 | 2 to 4 | 50 to 55 |
| 2 | 4 to 6 | 55 to 60 |
| 3 | 6 to 8 | 60 to 65 |
| 4 | 8 to 9 | 65 to 70 |
| 5 | 9 to 10 | 70 to 75 |
| 6 | 10 to 11 | 75 to 80 |
| 7 | 11 to 12 | 80 to 85 |
| 8 | 12 to 13 | 85 to 90 |
| 9 | 13 to 14 | 90 to 95 |
| 10 | 14 to 15 | 95 to 100 |
| 11 | 15 to 16 | 100 to 105 |
| 12 | 16 to 17 | 105 to 110 |
| 13 | 17 to 18 | 110 to 115 |
| 14 | 18 to 19 | 115 to 120 |
| 15 | 19 to 20 | >120 |
| 16 | 20 to 21 | |
| 17 | 21 to 22 | |
| 18 | 22 to 23 | |
| 19 | 23 to 24 | |
| 20 | 24 to 26 | |
| 21 | 26 to 28 | |
| 22 | 28 to 30 | |
| 23 | 30 to 32 | |
| 24 | 32 to 34 | |
| 25 | 34 to 36 | |
| 26 | 36 to 38 | |
| 27 | 38 to 41 | |
| 28 | 41 to 44 | |
| 29 | 44 to 47 | |
| 30 | 47 to 50 | |
| 31 | >50 | |

In the above data shown in Table 3, if 5 bits are allocated to saving the SH values, the resolution for the range of 0 to 50° F. will be 1.6° F. (50/2). The SH value is normally in the range of 10 to 20° F., so the highest resolution is desired in this range. The bin method can be used to provide a resolution of 1° F. in the desired range and a resolution of 2 or 3° F. in ranges where the resolution is less critical. Using the approach of the present invention, the method provides improved data resolution (in the most important range) for the same memory requirement (5 bits). There is also a potential reduction in memory use associated with multiple bin occurrences (increment bin counter instead of separate record). The data storage for the OAT values is 16 bins or 4 bits.

In general, a binary bin designation for the two parameters could be defined as xxxxx yyyy, where xxxxx represents the SH bin and yyyy represents the OAT bin. Example hypothetical measurements are presented in Table 4 with the corresponding bin designation.

TABLE 4
Example Bin Data for SH and OAT Data.

| | Outdoor Air | Bin | Bin |
|---|---|---|---|
| Superheat (° F.) | Temperature (° F.) | ID (dec) | ID (binary) |
| 24.2 | 74.5 | 20 05 | 10100 0101 |
| 19.5 | 83.1 | 15 07 | 01111 0111 |
| 15.1 | 90.7 | 11 09 | 01011 1001 |
| 7.4 | 97.0 | 03 10 | 00011 1010 |

For the example shown above, there are 32×16=512 unique bins; however, it likely that most of the data will be concentrated in a small group of bins. Thus,
Where data are collected for one-minute intervals over the period of one day, there will be 1,440 data sets (i.e., 24 hours/day×60 min/hour×1 data set/min=1,440 data sets/day);
If a basic data storage approach were to be used where 1 byte (8 bits) was assigned to SH and 1 byte (8 bits) was assigned to OAT, the total amount of data for one day would require 2,880 bytes (i.e., 2 bytes/data set×1,440 data sets=2,880 bytes);
One might wish to have a bin data structure with 3 bytes (24 bits) assigned to each record to account for the SH bin (1 byte), OAT bin (1 byte), and the occurrence count (1 byte);
With the defined bin structure, the maximum number of records is 512, resulting in a maximum memory use of 1,536 bytes (i.e., 3 bytes/record×512 maximum records=1,536 bytes);
The bin structure could be expanded to 32 bins×64 bins, which would result in 2,048 unique combinations. (This will fit in the 3 bytes assigned.);
The maximum number of binned records for a day would be 1,440 data sets (based on the number of minutes), but those bins would only be used if each record was found to be a unique combination of the two bins;
Thus, memory savings will result from data sets being assigned to common bins. If half of the data sets for a day were unique, based on the above bin structure, 2,160 bytes would be used (i.e., 1,440/2)×3=2,160 bytes would be required).

In the scheme above, the memory used would be 2,160 bytes compared to 2,880 bytes in the basic data storage approach. Thus, less memory is required and less data needs to be communicated over communications networks.

Additionally, conditions can be defined to identify when data should be saved and data should not be saved, further reducing memory requirements. This savings is illustrated by the HVAC&R air system and control performance example discussed in detail below. The approach described above can be expanded to bin any number of related parameters collectively to retain the correlation between the dependent and independent parameters.

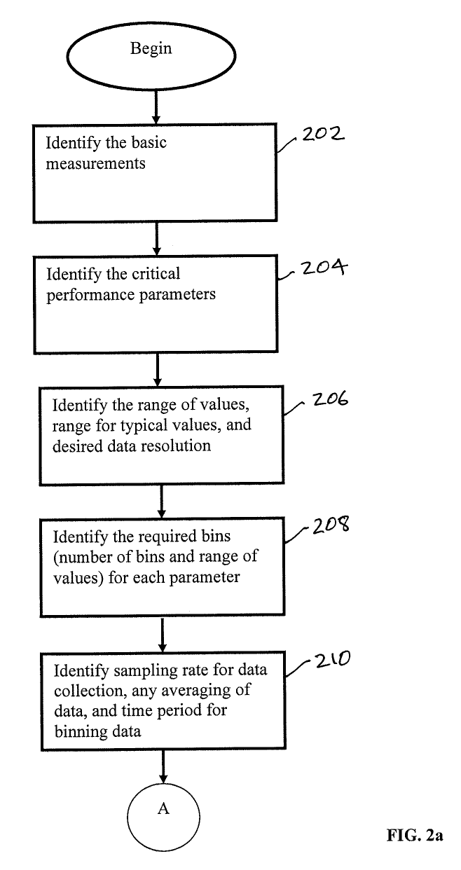

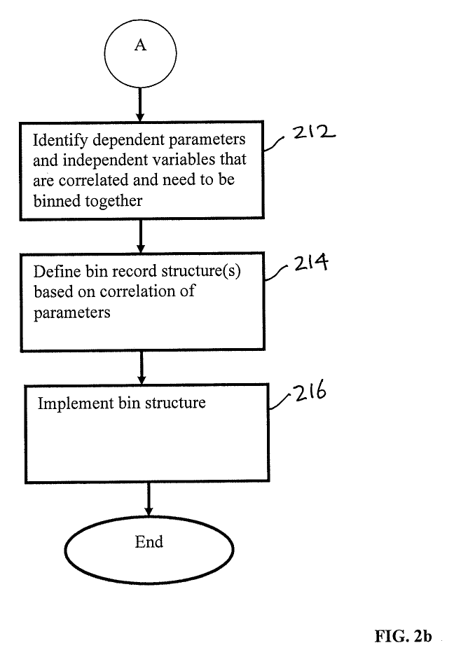

Turning now to FIGS. 2A and 2B, shown therein is a general process flow diagram of one embodiment of the invention for use in any suitable system where data logging is useful or desirable. In step 202, the basic parameters to be measured are identified. These parameters may be, for example, SH and OAT, but could be any system parameters of interest (as mentioned above and discussed below).

In step 204, the critical performance parameters for the equipment or system are identified. These critical performance parameters may include both measured values and computed values. From the parameters, the related independent and dependent parameters are then identified.

In step 206, for each critical performance parameter, the range of values, range for typical values, and desired data resolution for each of those ranges are identified.

In step 208, the required bins (i.e., number of bins and range of values) for each parameter to achieve the desired data range and resolution are then identified.

In step 210, the sampling rate for data collection, any averaging of data, and time period for binning the data (e.g., sample at 20 Hz, average data for one-minute interval, and bin on a daily basis), are identified.

In step 212, the dependent parameters and the independent variables that are correlated with each other are identified and for which it is desirable that they be binned together are identified.

In step 214, a suitable bin record structure or structures based on the correlation of parameters and variables in step 212 is/are identified.

Finally, in step 216, the specific bin structure thus identified in step 214 is implemented.

The system and method according to the present invention is well suited for data processing and storage associated with monitoring thermal equipment and related systems including, as noted above, monitoring HVAC&R equipment and systems. Example uses of the data monitored by the present invention include, but are not limited to, monitoring system performance (e.g., energy use, etc.), identification of equipment failure, and performing equipment or system diagnostics.

Additional embodiments of the present invention are now described by way of three non-limiting examples: HVAC&R air system and control performance monitoring using real-time operation data, refrigeration system performance monitoring using steady-state operation data, and overall HVAC system performance monitoring using cooling cycle data.

### Example 1

### HVAC&R Air System and Control

This example illustrates the data processing method of the present invention as it is applied to a system that has multiple independent variables (analog and digital) and two key dependent parameters. The example also illustrates variable data resolution (bin width) and data filtering based on operating mode.

For air system and control monitoring, system inputs (measured values) are identified in Table 5 and calculated parameters are identified in Table 6.

TABLE 5
Measured Air Temperature and Thermostat Data.

| Parameter | Code | Data Type | Units | Notes |
|---|---|---|---|---|
| Thermostat stage 1 call | Y1 | Digital Input | off/on | |
| for cooling status (Y1) | | | | |
| Thermostat Stage 2 call | Y2 | Digital Input | off/on | |
| for cooling status (Y2) | | | | |
| Thermostat Stage 1 call | W1 | Digital Input | off/on | |
| for heating status (W1) | | | | |
| Thermostat Stage 2 call | W2 | Digital Input | off/on | |
| for heating status (W2) | | | | |
| Thermostat Fan status | G | Digital Input | off/on | |
| Indoor Airflow Input | AI | Analog Input | | |
| Indoor Airflow status | FAN | Calculated | off/on | FAN = on when AI > threshold; |
| | | | | otherwise, FAN = off |
| Outdoor air temperature | OAT | Analog Input | ° F. | |
| Return air temperature | RAT | Analog Input | ° F. | |
| Mixed air temperature | MAT | Analog Input | ° F. | |
| Supply air temperature | SAT | Analog Input | ° F. | |
| Outdoor air humidity | OAH | Analog Input | % RH | |
| Return air humidity | RAH | Analog Input | % RH | |

TABLE 6
Computed Air Temperature and Thermostat Data.

| Parameter | Code | Units | Notes |
|---|---|---|---|
| Indoor Airflow | FAN | Off/on | FAN = on when AI > threshold; |
| status | | | otherwise, FAN = off |
| Return air | Rh | Btu/lb | Calculated from RAT and |
| enthalpy | | | RAH |
| Mechanical | MCOOL | off/on | Determined from refrigeration |
| cooling status | | | system pressures |
| Economizer | ECOOL | off/on | On status indicated by |
| cooling status | | | Equations 5 and 6 |
| Heating status | HEAT | off/on | HEAT = on when (SAT- |
| | | | MAT) > 10° F.; otherwise, |
| | | | HEAT = off |
| Outdoor Air | OAF | — | Refer to Equation 3 |
| Fraction | | | |
| Occupancy Mode | OM | — | Determined from occupancy |
| | | | schedule and day/time; |
| | | | 0 = unoccupied, 1 = occupied |

The bin structures are defined for thermostat inputs (Table 10) and for airside data (Table 11).

TABLE 10
Bin Structure for Thermostat Data.

| Bin | Airflow | Y1 | Y2 | W1 | W2 | G | OM |
|---|---|---|---|---|---|---|---|
| 0 | Off | Off | Off | Off | Off | Off | Unoccupied |
| 1 | On | On | On | On | On | On | Occupied |

TABLE 11
Bin Structure for Air Temperature Data.

| | | | OAT-RAT | | | |
|---|---|---|---|---|---|---|
| Bin | RAT (° F.) | MAT-RAT (° F.) | (° F.) | SAT (° F.) | RAH (%) | OAH (%) |
| 0 | <40 | <−45 | <−95 | <45 | 0 to 10 | 0 to 10 |
| 1 | 40 to 60 | −45 to −25 | −95 to −60 | 45 to 50 | 10 to 20 | 10 to 20 |
| 2 | 60 to 65 | −25 to −22 | −60 to −30 | 50 to 55 | 20 to 25 | 20 to 25 |
| 3 | 65 to 67 | −22 to −20 | −30 to −25 | 55 to 60 | 25 to 30 | 25 to 30 |
| 4 | 67 to 69 | −20 to −19 | −25 to −20 | 60 to 65 | 30 to 35 | 30 to 35 |
| 5 | 69 to 71 | −19 to −18 | −20 to −17 | 65 to 70 | 35 to 40 | 35 to 40 |
| 6 | 71 to 73 | −18 to −17 | −17 to −15 | 70 to 75 | 40 to 45 | 40 to 45 |
| 7 | 73 to 75 | −17 to −16 | −15 to −14 | 75 to 85 | 45 to 50 | 45 to 50 |
| 8 | 75 to 77 | −16 to −15 | −14 to −13 | 85 to 89 | 50 to 55 | 50 to 55 |
| 9 | 77 to 79 | −15 to −14 | −13 to −12 | 89 to 93 | 55 to 60 | 55 to 60 |
| 10 | 79 to 81 | −14 to −13 | −12 to −11 | 93 to 97 | 60 to 65 | 60 to 65 |
| 11 | 81 to 83 | −13 to −12 | −11 to −10 | 97 to 101 | 65 to 70 | 65 to 70 |
| 12 | 83 to 85 | −12 to −11 | −10 to −9 | 101 to 105 | 70 to 75 | 70 to 75 |
| 13 | 85 to 90 | −11 to −10 | −9 to −8 | 105 to 110 | 75 to 80 | 75 to 80 |
| 14 | 90 to 110 | −10 to −9 | −8 to −7 | 110 to 130 | 80 to 90 | 80 to 90 |
| 15 | >110 | −9 to −8 | −7 to −6 | >130 | 90 to 100 | 90 to 100 |
| 16 | | −8 to −7 | −6 to −5 | | | |
| 17 | | −7 to −6 | −5 to 0 | | | |
| 18 | | −6 to −5 | 0 to 5 | | | |
| 19 | | −5 to 0 | 5 to 6 | | | |
| 20 | | 0 to 2 | 6 to 7 | | | |
| 21 | | 2 to 3 | 7 to 8 | | | |
| 22 | | 3 to 4 | 8 to 9 | | | |
| 23 | | 4 to 5 | 9 to 10 | | | |
| 24 | | 5 to 6 | 10 to 11 | | | |
| 25 | | 6 to 7 | 11 to 12 | | | |
| 26 | | 7 to 8 | 12 to 13 | | | |
| 27 | | 8 to 9 | 13 to 14 | | | |
| 28 | | 9 to 10 | 14 to 15 | | | |
| 29 | | 10 to 15 | 15 to 20 | | | |
| 30 | | 15 to 30 | 20 to 50 | | | |
| 31 | | >30 | >50 | | | |

In this example, the key dependent parameters for the system operation are identified as (MAT-RAT) and SAT. The remaining parameters are considered to be independent parameters: Y1, Y2, OM, G, RAT, RAH, (OAT-RAT), and OAH. The time period for binning data is identified as one day, so bin records include a date stamp and occurrences are tabulated for each day. The air system and control data are filtered based on the airflow status because valid air temperature measurements are available only when the indoor fan is on. The data are also grouped based on occupancy mode. The bin structures are used to create bin records for airside performance with the information indicated in Table 14 for fan on operation and Table 15 for fan off operation.

TABLE 14
Airside Data Record Structure (FAN = On).

| Parameter | Bins | Bits | Notes |
|---|---|---|---|
| Data Type | — | 3 | |
| Y1 | 2 | 1 | Refer to Table 10 |
| Y2 | 2 | 1 | Refer to Table 10 |
| W1 | 2 | 1 | Refer to Table 10 |
| W2 | 2 | 1 | Refer to Table 10 |
| G | 2 | 1 | Refer to Table 10 |
| RAT | 16 | 4 | Refer to Table 11 |
| MAT-RAT | 32 | 5 | Refer to Table 11 |
| OAT-RAT | 32 | 5 | Refer to Table 11 |
| SAT | 16 | 4 | Refer to Table 11 |
| RAH | 16 | 4 | Refer to Table 11 |
| OAH | 16 | 4 | Refer to Table 11 |
| OM | 2 | 1 | Refer to Table 10 |
| Occurrences | — | 9 | |
| Date ID | — | 16 | |
| Unit ID | — | 16 | |

TABLE 15
Airside Data Record Structure (FAN = Off).

| Parameter | Bins | Bits | Notes |
|---|---|---|---|
| Data Type | — | 3 | |
| Y1 | 2 | 1 | Refer to Table 10 |
| Y2 | 2 | 1 | Refer to Table 10 |
| W1 | 2 | 1 | Refer to Table 10 |
| W2 | 2 | 1 | Refer to Table 10 |
| G | 2 | 1 | Refer to Table 10 |
| OM | 2 | 1 | Refer to Table 10 |
| Occurrences | — | 9 | |
| Date ID | — | 16 | |
| Unit ID | — | 16 | |

An alternate bin structure may be desirable when an enthalpy-based economizer control strategy is used.

### Example 2

### HVAC&R Refrigeration (Compressor) Cooling

This example illustrates the data processing method according to the present invention applied to a system that has two independent variables and four key dependent parameters. The example also illustrates the use of performance parameters, variable data resolution (bin width), and data filtering based on operating conditions.

For monitoring of refrigeration cooling associated with an air conditioning unit or heat pump, the system inputs are identified in Table 7 and calculated parameters are identified in Table 8.

TABLE 7
Measured Refrigeration Data.

| Parameter | Code | Data Type | Units | Notes |
|---|---|---|---|---|
| Suction pressure | SP | Analog Input | psig | |
| Liquid pressure | LP | Analog Input | psig | |
| Suction temperature | ST | Analog Input | ° F. | |
| Liquid temperature | LT | Analog Input | ° F. | |

TABLE 8
Computed Refrigeration Data.

| Parameter | Code | Units | Notes |
|---|---|---|---|
| Superheat | SH | ° F. | SH = ST − ET |
| Subcooling | SC | ° F. | SC = CT − LT |
| Evaporating temperature | ET | ° F. | Evaporating temperature (ET) |
| | | | calculated from SP. |
| Condensing temperature | COA | ° F. | Condensing temperature (CT) |
| over ambient (outdoor) | | | calculated from LP. |
| temperature | | | COA = CT − OAT |
| Mixed air wet-bulb | MWB | ° F. | Refer to FIG. 6 for |
| temperature | | | calculation procedure |

The critical independent variables are identified as OAT and MWB for cooling operation. The critical performance parameters or dependent variables are identified as SH, SC, evaporative temperature (ET), and COA for cooling operation. Transient data are filtered out to retain only quasi-steady data. A suggested bin structure for these parameters is presented in Table 12. The bin structures are used to create bin records with the information indicated in Table 17.

TABLE 12
Bin Structure for Refrigeration Data (Cooling).

| Bin | SH (° F.) | SC (° F.) | ET (° F.) | COA (° F.) | OAT (° F.) | MWB (° F.) |
|---|---|---|---|---|---|---|
| 0 | <−32 | <−40 | <−12 | <−32 | <0 | <40 |
| 1 | −32 to −22 | −40 to −30 | −12 to −2 | −32 to −22 | 0 to 10 | 40 to 60 |
| 2 | −22 to −12 | −30 to −20 | −2 to 8 | −22 to −12 | 10 to 20 | 60 to 65 |
| 3 | −12 to −7 | −20 to −15 | 8 to 13 | −12 to −7 | 20 to 30 | 65 to 67 |
| 4 | −7 to −2 | −15 to −10 | 13 to 18 | −7 to −2 | 30 to 40 | 67 to 69 |
| 5 | −2 to 0 | −10 to −8 | 18 to 20 | −2 to 0 | 40 to 50 | 69 to 71 |
| 6 | 0 to 2 | −8 to −6 | 20 to 22 | 0 to 2 | 50 to 52 | 71 to 73 |
| 7 | 2 to 4 | −6 to −4 | 22-24 | 2 to 4 | 52 to 54 | 73 to 75 |
| 8 | 4 to 6 | −4 to −2 | 24-26 | 4 to 6 | 54 to 56 | 75 to 77 |
| 9 | 6 to 8 | −2 to 0 | 26-28 | 6 to 8 | 56 to 58 | 77 to 79 |
| 10 | 8-10 | 0 to 2 | 28 to 30 | 8 to 10 | 58 to 60 | 79 to 81 |
| 11 | 10-12 | 2 to 4 | 30 to 32 | 10 to 12 | 60 to 62 | 81 to 83 |
| 12 | 12-14 | 4 to 6 | 32 to 34 | 12-14 | 62 to 64 | 83 to 85 |
| 13 | 14-16 | 6-8 | 34-36 | 14-16 | 64 to 66 | 85 to 90 |
| 14 | 16-18 | 8-10 | 36-38 | 16-18 | 66 to 68 | 90 to 110 |
| 15 | 18-20 | 10-12 | 38-40 | 18-20 | 68 to 70 | >110 |
| 16 | 20-22 | 12-14 | 40-42 | 20-22 | 70 to 72 | |
| 17 | 22-24 | 14-16 | 42-44 | 22-24 | 72 to 74 | |
| 18 | 24-26 | 16-18 | 44-46 | 24-26 | 74 to 76 | |
| 19 | 26-28 | 18-20 | 46-48 | 26-28 | 76 to 78 | |
| 20 | 28-30 | 20-22 | 48-50 | 28-30 | 78 to 80 | |
| 21 | 30-32 | 22-24 | 50 to 52 | 30-32 | 80 to 82 | |
| 22 | 32-34 | 24-26 | 52 to 54 | 32-34 | 82 to 84 | |
| 23 | 34-36 | 26-28 | 54 to 56 | 34-36 | 84 to 86 | |
| 24 | 36-38 | 28-30 | 56 to 58 | 36-38 | 86 to 88 | |
| 25 | 38-40 | 30-32 | 58 to 60 | 38-40 | 88 to 90 | |
| 26 | 40-42 | 32-34 | 60 to 62 | 40-42 | 90 to 95 | |
| 27 | 42-47 | 34-39 | 62 to 67 | 42-47 | 95 to 100 | |
| 28 | 47-52 | 39-44 | 67 to 72 | 47-52 | 100 to 105 | |
| 29 | 52 to 62 | 44 to 54 | 72 to 82 | 52 to 62 | 105 to 110 | |
| 30 | 62 to 72 | 54 to 64 | 82 to 92 | 62 to 72 | 110 to 115 | |
| 31 | >72 | >64 | >92 | >72 | >115 | |

TABLE 17
Refrigeration Data (Cooling) Record Structure.

| Parameter | Bins | Bits | Notes |
|---|---|---|---|
| Data Type | — | 3 | |
| SH | 32 | 5 | Refer to Table 12 |
| SC | 32 | 5 | Refer to Table 12 |
| ET | 32 | 5 | Refer to Table 12 |
| COA | 32 | 5 | Refer to Table 12 |
| OAT | 32 | 5 | Refer to Table 12 |
| MWB | 16 | 4 | Refer to Table 12 |
| Occurrences | — | 9 | |
| Date ID | — | 16 | |
| Unit ID | — | 16 | |

### Example 3

### Overall HVAC&R System Performance

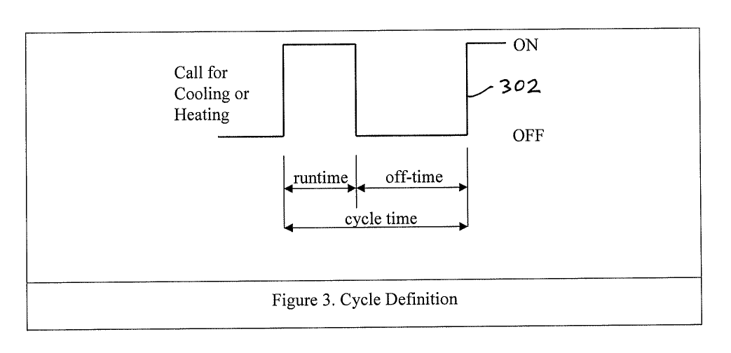

In this example the data processing method according to the present invention is applied to a system that has two independent variables and five key dependent parameters. The example also illustrates the use of performance parameters, variable data resolution (bin width), and data filtering. Turning to FIG. 3, shown therein is graph of a cooling cycle load 302 defined by the thermostat call for cooling of an air conditioning device between ON and OFF loads. In this example, a 2-stage cooling thermostat and a unit with two stages of compressor cooling are being employed. For unit cooling cycle performance, the calculated parameters are identified in Table 9.

TABLE 9
Computed Cycle Parameters (Cooling)

| Parameter | Code | Units | Notes |
|---|---|---|---|
| Y1 Call for cooling time | CC1T | Minutes | |
| Y2 Call for cooling time | CC2T | Minutes | |
| Stage 1 compressor runtime | C1RT | Minutes | |
| Stage 1 compressor off-time | C1OT | Minutes | |
| Stage 2 compressor runtime | C2RT | Minutes | |
| Stage 2 compressor off-time | C2OT | Minutes | |
| Stage 3 compressor runtime | C3RT | Minutes | |
| Stage 3 compressor off-time | C3OT | Minutes | |
| Stage 4 compressor runtime | C4RT | Minutes | |
| Stage 4 compressor off-time | C4OT | Minutes | |
| Economizer runtime | ERT | Minutes | |
| Economizer off-time | EOT | Minutes | |
| Cycle time | CT | Minutes | |
| Cycle average outdoor air | OATa | ° F. | |
| temperature | | | |
| Cycle average return air | RATa | ° F. | |
| temperature | | | |
| Compressor runtime fraction | CRF | — | Refer to Equation 1 |
| Economizer runtime fraction | ERF | — | Refer to Equation 2 |

In this example, the measured data are essentially “filtered” to obtain cycle parameters such as cycle time and compressor runtime. The unit compressor runtime fraction, CRF, is defined for a 2-stage unit as

$$CRF = \frac{( C 1 RT \cdot {CC}_{1} ) + ( C 2 RT \cdot {CC}_{2} )}{CT ( {CC}_{1} + {CC}_{2} )} \qquad ( 1 )$$

Where CC₁ and CC₂ are the nominal cooling capacities for the stages. Economizer runtime fraction, ERF, is defined as

$$ERF = \frac{ERT}{CT} \qquad ( 2 )$$

The critical independent variables are identified as OATa and return air temperature (RATa) for cooling operation. The critical performance parameters or dependent variables are identified as CC1T, CC2T, CT, CRF, and ERF for cooling operation. Bin structures are defined for cooling cycle parameters in Table 13. The bin structures are used to create bin records with the information indicated in Table 16.

TABLE 13
Bin Structure for Cooling Cycle Data.

| | | | | | | OATa | |
|---|---|---|---|---|---|---|---|
| Bin | CC1T | CC2T | CT | CRF | ERF | (° F.) | RATa (° F.) |
| 0 | 0 | 0 | 0 | 0 | 0 | <0 | <40 |
| 1 | 0 to 1 | 0 to 1 | 0 to 1 | 0 to 0.1 | 0 to 0.1 | 0 to 10 | 40 to 60 |
| 2 | 1 to 2 | 1 to 2 | 1 to 2 | 0.1 to 0.2 | 0.1 to 0.2 | 10 to 20 | 60 to 65 |
| 3 | 2 to 3 | 2 to 3 | 2 to 3 | 0.2 to 0.3 | 0.2 to 0.3 | 20 to 30 | 65 to 67 |
| 4 | 3 to 4 | 3 to 4 | 3 to 4 | 0.3 to 0.4 | 0.3 to 0.4 | 30 to 40 | 67 to 69 |
| 5 | 4 to 5 | 4 to 5 | 4 to 5 | 0.4 to 0.5 | 0.4 to 0.5 | 40 to 50 | 69 to 71 |
| 6 | 5 to 6 | 5 to 6 | 5 to 6 | 0.5 to 0.6 | 0.5 to 0.6 | 50 to 52 | 71 to 73 |
| 7 | 6 to 7 | 6 to 7 | 6 to 7 | 0.6 to 0.65 | 0.6 to 0.65 | 52 to 54 | 73 to 75 |
| 8 | 7 to 8 | 7 to 8 | 7 to 8 | 0.65 to 0.7 | 0.65 to 0.7 | 54 to 56 | 75 to 77 |
| 9 | 8 to 9 | 8 to 9 | 8 to 9 | 0.7 to 0.75 | 0.7 to 0.75 | 56 to 58 | 77 to 79 |
| 10 | 9 to 10 | 9 to 10 | 9 to 10 | 0.75 to 0.8 | 0.75 to 0.8 | 58 to 60 | 79 to 81 |
| 11 | 10 to 11 | 10 to 11 | 10 to 11 | 0.8 to 0.85 | 0.8 to 0.85 | 60 to 62 | 81 to 83 |
| 12 | 11 to 12 | 11 to 12 | 11 to 12 | 0.85 to 0.9 | 0.85 to 0.9 | 62 to 64 | 83 to 85 |
| 13 | 12 to 13 | 12 to 13 | 12 to 13 | 0.9 to 0.95 | 0.9 to 0.95 | 64 to 66 | 85 to 90 |
| 14 | 13 to 14 | 13 to 14 | 13 to 14 | 0.95 to 1.0 | 0.95 to 1.0 | 66 to 68 | 90 to 100 |
| 15 | 14 to 15 | 14 to 15 | 14 to 15 | 1.0 | 1.0 | 68 to 70 | >100 |
| 16 | 15 to 16 | 15 to 16 | 15 to 16 | | | 70 to 72 | |
| 17 | 16 to 17 | 16 to 17 | 16 to 17 | | | 72 to 74 | |
| 18 | 17 to 18 | 17 to 18 | 17 to 18 | | | 74 to 76 | |
| 19 | 18 to 19 | 18 to 19 | 18 to 19 | | | 76 to 78 | |
| 20 | 19 to 20 | 19 to 20 | 19 to 20 | | | 78 to 80 | |
| 21 | 20 to 21 | 20 to 21 | 20 to 21 | | | 80 to 82 | |
| 22 | 21 to 22 | 21 to 22 | 21 to 22 | | | 82 to 84 | |
| 23 | 22 to 23 | 22 to 23 | 22 to 23 | | | 84 to 86 | |
| 24 | 23 to 24 | 23 to 24 | 23 to 24 | | | 86 to 88 | |
| 25 | 24 to 25 | 24 to 25 | 24 to 25 | | | 88 to 90 | |
| 26 | 25 to 26 | 25 to 26 | 25 to 26 | | | 90 to 100 | |
| 27 | 26 to 27 | 26 to 27 | 26 to 27 | | | 100 to 110 | |
| 28 | 27 to 28 | 27 to 28 | 27 to 28 | | | 110 to 120 | |
| 29 | 28 to 29 | 28 to 29 | 28 to 29 | | | 120 to 130 | |
| 30 | 29 to 30 | 29 to 30 | 29 to 30 | | | 130 to 140 | |
| 31 | 30 to 35 | 30 to 35 | 30 to 35 | | | >140 | |
| 32 | 35 to 40 | 35 to 40 | 35 to 40 | | | | |
| 33 | 40 to 45 | 40 to 45 | 40 to 45 | | | | |
| 34 | 45 to 50 | 45 to 50 | 45 to 50 | | | | |
| 35 | 50 to 55 | 50 to 55 | 50 to 55 | | | | |
| 36 | 55 to 60 | 55 to 60 | 55 to 60 | | | | |
| 37 | 60 to 70 | 60 to 70 | 60 to 70 | | | | |
| 38 | 70 to 80 | 70 to 80 | 70 to 80 | | | | |
| 39 | 80 to 90 | 80 to 90 | 80 to 90 | | | | |
| 40 | 90 to 100 | 90 to 100 | 90 to 100 | | | | |
| 41 | 100 to 110 | 100 to 110 | 100 to 110 | | | | |
| 42 | 110 to 120 | 110 to 120 | 110 to 120 | | | | |
| 43 | 120 to 140 | 120 to 140 | 120 to 140 | | | | |
| 44 | 140 to 160 | 140 to 160 | 140 to 160 | | | | |
| 45 | 160 to 180 | 160 to 180 | 160 to 180 | | | | |
| 46 | 180 to 210 | 180 to 210 | 180 to 210 | | | | |
| 47 | 210 to 240 | 210 to 240 | 210 to 240 | | | | |
| 48 | 240 to 270 | 240 to 270 | 240 to 270 | | | | |
| 49 | 270 to 300 | 270 to 300 | 270 to 300 | | | | |
| 50 | 300 to 330 | 300 to 330 | 300 to 330 | | | | |
| 51 | 330 to 360 | 330 to 360 | 330 to 360 | | | | |
| 52 | 360 to 390 | 360 to 390 | 360 to 390 | | | | |
| 53 | 390 to 420 | 390 to 420 | 390 to 420 | | | | |
| 54 | 420 to 480 | 420 to 480 | 420 to 480 | | | | |
| 55 | 480 to 540 | 480 to 540 | 480 to 540 | | | | |
| 56 | 540 to 600 | 540 to 600 | 540 to 600 | | | | |
| 57 | 600 to 660 | 600 to 660 | 600 to 660 | | | | |
| 58 | 660 to 720 | 660 to 720 | 660 to 720 | | | | |
| 59 | 720 to 840 | 720 to 840 | 720 to 840 | | | | |
| 60 | 840 to 960 | 840 to 960 | 840 to 960 | | | | |
| 61 | 960 to 1080 | 960 to 1080 | 960 to 1080 | | | | |
| 62 | 1080 to 1200 | 1080 to 1200 | 1080 to 1200 | | | | |
| 63 | 1200 to 1440 | 1200 to 1440 | 1200 to 1440 | | | | |

TABLE 16
Cooling Cycle Data Record Structure.

| Parameter | Bins | Bits | Notes |
|---|---|---|---|
| Data Type | — | 3 | |
| CC1T | 64 | 6 | Refer to Table 13 |
| CC2T | 64 | 6 | Refer to Table 13 |
| CT | 64 | 6 | Refer to Table 13 |
| CRF | 16 | 4 | Refer to Table 13 |
| ERF | 16 | 4 | Refer to Table 13 |
| OATa | 32 | 5 | Refer to Table 13 |
| RATa | 16 | 4 | Refer to Table 13 |
| Occurrences | — | 7 | |
| Date ID | — | 16 | |
| Unit ID | — | 16 | |

An additional parameter for economizer and outdoor air performance is outdoor air fraction, OAF, defined as

$$OAF = \frac{MAT - RAT}{OAT - RAT} \qquad ( 3 )$$

OAF is considered to be valid when (a) airflow is verified, (b) the associated temperature inputs are valid and (c) |OAT−RAT|>5° F. The OAF may be computed from the binned data parameters identified in Table 11 or it could alternately be calculated from the input data and included as a binned parameter.

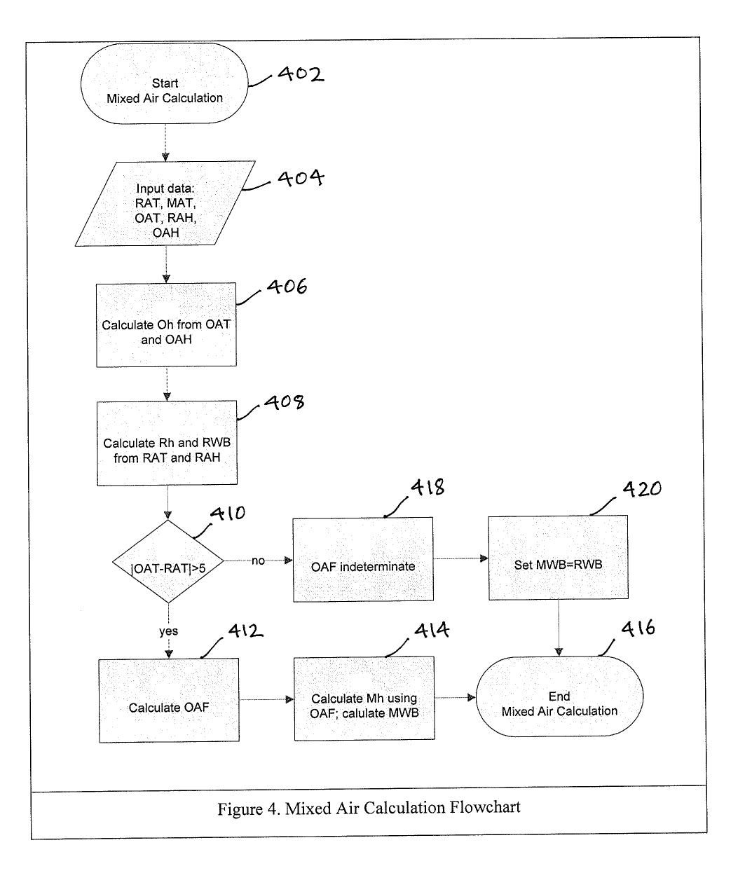

In the examples presented, only the mixed air dry-bulb temperature is measured. Other mixed air properties are calculated based on the outdoor air fraction as outlined in FIG. 4, which is a process flow diagram for a mixed air calculation according to one embodiment of the present invention. As shown in the figure, in step 402, the mixed air calculation algorithm is begun. In step 404, certain performance parameter input data are input, including RAT, MAT, OAT, RAH, and OAH. In step 406, the Oh is calculated from the OAT and OAH values. In step 408, the Rh and RWB are calculated from the RAT and RAH values. In decision step 410, if the absolute value |OAT−RAT|>5, the either steps 412 or 418 are performed. In step 412, if the decision step 410 is “yes,” the OAG is calculated, then, in step 414, the mixed air enthalpy, Mh, is calculated using the OAF, and then the MWB is calculated. In step 416, the mixed air calculation is stopped. In step 418, if the decision step 410 is “no,” then the OAF is set to be indeterminate, and then, in step 420, the MWB is set to equal RWB.

Mixed air enthalpy is calculated using the OAF as follows:

Mh=OAF(Oh−Rh)+Rh (4)

The indoor airflow status (on/off) is determined from one of the sensors 104 (see FIG. 1). The mechanical cooling status (on/off) is determined from refrigeration system pressure measurements. The economizer cooling status is determined from airside measurements and is considered to be on when

(OAT−RAT)<−5° F. (5)

and

OAF>mOAF (6)

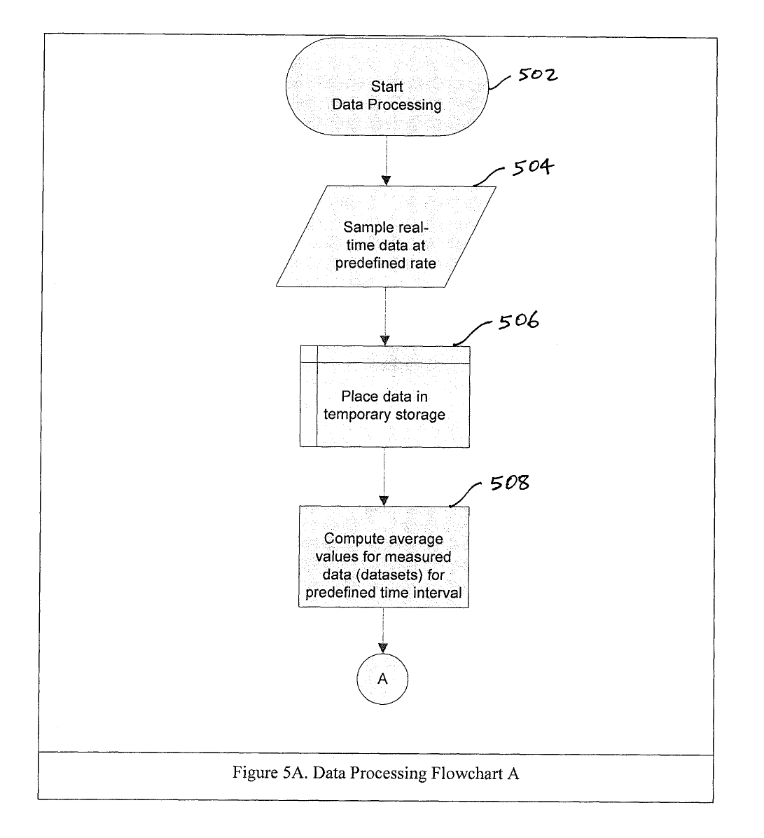

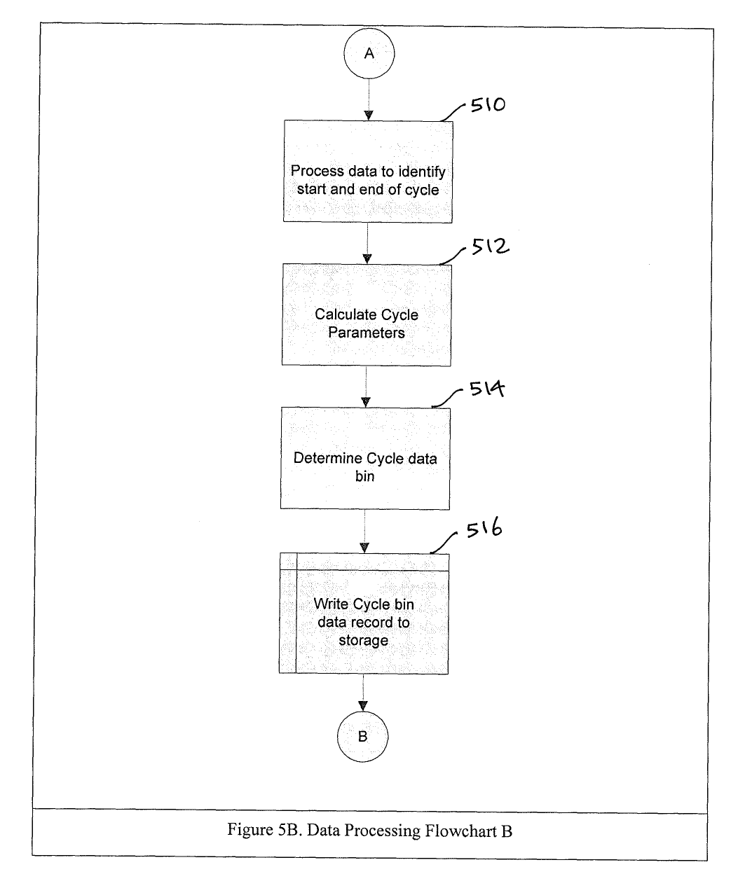

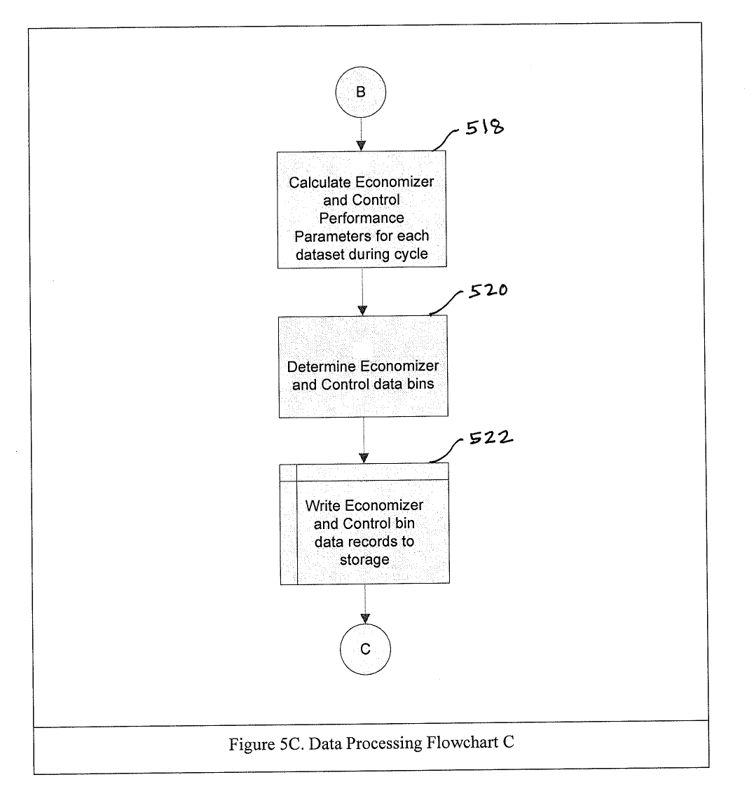

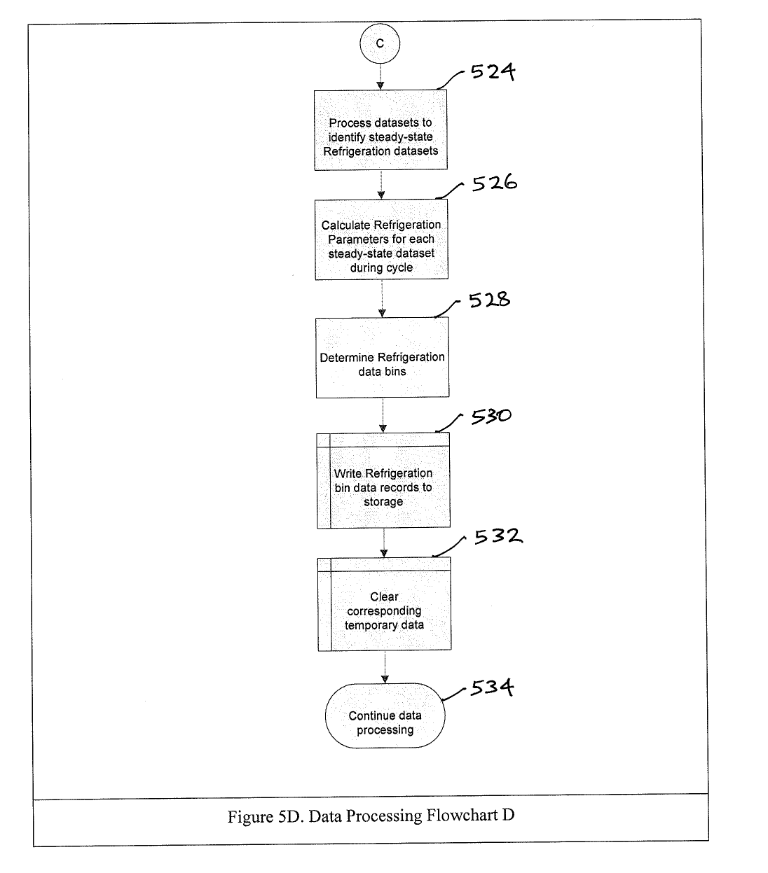

A suggested data processing scheme for implementing the examples (air system and control, refrigeration system, cooling cycle) is presented in FIGS. 5A through 5D. Here, E/C refers to economizer and control.

In step 502, the data processing algorithm is started. Then, in step 504, the system samples real-time data at a predefined frequency. In step 506, the data are stored in temporary storage. Next, in step 508, average values for the measured data (i.e., data sets) are computed for predefined time intervals.

In step 510, the data are processed to identify start and end cycles. In step 512, the cycle parameters are calculated. In step 514, the cycle data bin is determined. In step 516, the cycle bin data records are written to memory storage.

Next, in step 518, the E/C performance parameters for each data set are calculated for the cycle. In step 520, the E/C data bins are determined. In step 522, the E/C bin data records are written to memory storage.

Next, in step 524, the data sets are processed to identify steady-state refrigeration data sets. In step 526, refrigeration parameters for each steady-state data set are calculated for the cycle. In step 528, the refrigeration data bins are determined. In step 530, the refrigeration bin data records are written to a memory storage.

In step 532, the temporary data corresponding to the above steps are cleared. Finally, in step 534, the process ends.

A general expression for unit compressor runtime fraction, CRF, is

$$CRF = \frac{{\sum }_{i = 1}^{4} {CC}_{i} \cdot {CRT}_{i }}{CT {\sum }_{i = 1}^{4} {CC}_{i}} \qquad ( 7 )$$

As noted previously, the above system and method can be used to accumulate data for the evaluation of steady-state unit performance of an HVAC&R system. Once the appropriate data have been collected and stored, they may be made available as read-only values over a communications network, such as, but not limited to, a BACnet network. To accomplish this, the identity of the independent variables is first made, and the relevant independent variables are provided. An example is shown and summarized in Table 18.

TABLE 18
Independent Variables.

| ID | Symbol | Description | Type | Status |
|---|---|---|---|---|
| 1-20 | SF | Supply Fan Control Output Status | DOS | Used |
| 1-21 | CS1 | Compressor 1 Control Output Status | DOS | Used |
| 1-22 | CS2 | Compressor 2 Control Output Status | DOS | Used |
| 1-23 | H1 | Heat 1 Control Output Status | DOS | Used |
| 1-24 | RV | Reversing Valve Control Output | DOS | Used |
| | | Status | | |
| 1-25 | H2 | Heat 2 Control Output Status | DOS | Used |
| 1-26 | EH | Emergency Heat Control Output | DOS | Used |
| | | Status | | |
| 1-27 | PEF | Power Exhaust Fan Control Output | DOS | Used |
| | | Status | | |
| 1-28 | EC | Economizer Position | AOS | Used |
| 1-31 | ZAT | Zone Air Temperature | NSV | Used |
| 1-32 | BAH | Building Air Humidity | NSV | Used |
| 1-33 | RAT | Return Air Temperature | DSV | Not Used |
| 1-34 | RAH | Return Air Humidity | DSV | Not Used |
| 1-35 | OAT | Outside Air Temperature | NSV | Used |
| 1-36 | OAH | Outside Air Humidity | NSV | Used |

Once the above is done, then the dependent variables are identified. An example is shown and summarized in Table 19.

TABLE 19
Dependent Variables.

| ID | Symbol | Description | Type | Status |
|---|---|---|---|---|
| 1-3 | WUC | Whole Unit Current | DSV | Used |
| 1-4 | BUC | Indoor Blower Unit Current | DSV | Used |
| 1-5 | SAT | Supply Air Temperature | DSV | Used |
| 1-6 | ET1 | Evaporating Temperature - Circuit 1 | DSV | Used |
| 1-7 | SP1 | Suction Pressure - Circuit 1 | DSV | Not Used |
| 1-8 | ST1 | Suction Temperature - Circuit 1 | DSV | Used |
| 1-9 | CT1 | Condensing Temperature - Circuit 1 | DSV | Used |
| 1-10 | LP1 | Liquid Pressure - Circuit 1 | DSV | Not Used |
| 1-11 | DP1 | Discharge Pressure - Circuit 1 | DSV | Not Used |
| 1-12 | LT1 | Liquid Temperature - Circuit 1 | DSV | Used |
| 1-13 | ET2 | Evaporating Temperature - Circuit 2 | DSV | Used |
| 1-14 | SP2 | Suction Pressure - Circuit 2 | DSV | Not Used |
| 1-15 | ST2 | Suction Temperature - Circuit 2 | DSV | Used |
| 1-16 | CT2 | Condensing Temperature - Circuit 2 | DSV | Used |
| 1-17 | LP2 | Liquid Pressure - Circuit 2 | DSV | Not Used |
| 1-18 | DP2 | Discharge Pressure - Circuit 2 | DSV | Not Used |
| 1-19 | LT2 | Liquid Temperature - Circuit 2 | DSV | Used |

Then, the relevant state variables are defined, as shown and summarized in Table 20 with the following definitions (the current values can be read over, for example, a BACnet network at any time).

TABLE 20
State Variables

| ID | Symbol | Description | Type |
|---|---|---|---|
| 3-1 | MODE | Mode (1 = Cooling, 2 = Not cooling) | |
| 3-2 | SS_FLAG | Steady-state flag (0 = No, 1 = Yes) | |

In Table 20, “Control Mode” (MODE) is a state variable tracked in this software module. Its value is defined by the following sequence of operations:

1. Initialize to “1” (cooling mode) when the module is first initialized including at power cycling.

2. Set to “2” (not cooling mode) if:

3. AC heat on: (SYS_TYPE=AC (1) and (H1=ON (1) or H2=ON (1))) or

4. HP in heating mode or emergency heat: (SYS_TYPE=HP (2) and (EM=ON (1) or ((CS1=ON (1) or CS2=ON (1)) and ((RV_TYPE=1 (energize cool) and RV=OFF (0)) or (RV_TYPE=2 (energize heat) and RV=ON (1))))))

5. Set to “1” (cooling mode) if:

6. AC mechanical cooling: (SYS_TYPE=AC (1) and (CS1=ON (1) or CS2=ON (1))) or

7. AC economizer cooling: (SYS_TYPE=AC (1) and CS1=OFF (0) and CS2=OFF (0) and H1=OFF (0) and H2=OFF (0) and EC>50) or

8. HP mechanical cooling: (SYS_TYPE=HP (2) and ((CS1=ON (1) or CS2=ON (1)) and ((RV_TYPE=1 (energize cool) and RV=ON (1)) or (RV_TYPE=2 (energize heat) and RV=OFF (0))))) or

9. HP economizer cooling: (SYS_TYPE=HP(2) and CS1=OFF (0) and CS2=OFF (0) and EG=OFF (0) and EC>50)

10. “Steady-State Flag” (SS_FLAG) is a flag indicating if the unit is operating in steady-state. It is set to TRUE (1) if all the digital output status (DOS) variables in Table 18 have been unchanged for at least five minutes, otherwise it is FALSE (0).

Next, relevant performance indices (PIs) are defined as shown and summarized in Table 21 with the following definitions (their current values can be read over, for example, the BACnet network at any time).

TABLE 21
Performance Indices (PIs)

| ID | Symbol | Description | Type |
|---|---|---|---|
| 3-3 | ITD | Indoor temperature difference | PI |
| 3-4 | ETc1 | Evaporating temperature, corrected - Circuit 1 | PI |
| 3-5 | ETc2 | Evaporating temperature, corrected - Circuit 2 | PI |
| 3-6 | SH1 | Superheat - Circuit 1 | PI |
| 3-7 | SH2 | Superheat - Circuit 2 | PI |
| 3-8 | CTc1 | Condensing temperature, corrected - Circuit 1 | PI |
| 3-9 | CTc2 | Condensing temperature, corrected - Circuit 2 | PI |
| 3-10 | COA1 | Condensing temperature over ambient - Circuit 1 | PI |
| 3-11 | COA2 | Condensing temperature over ambient - Circuit 2 | PI |
| 3-12 | SC1 | Subcooling - Circuit 1 | PI |
| 3-13 | SC2 | Subcooling - Circuit 2 | PI |
| 3-14 | WUCn | Whole Unit Current, normalized | PI |
| 3-15 | BUCn | Indoor Blower Unit Current, normalized | PI |

Next, all of the parameters are defined for cooling mode operation. Refrigeration cycle parameters are defined for circuit 1 in the equations shown below. However, similar calculations would be performed for circuit 2. Both circuit 1 and 2 values are shown in Table 21.

Corrected Evaporating Temperature (ETc):

If the evaporating temperature is measured directly with a temperature sensor in the two-phase region of the indoor coil, then its value is corrected for the temperature difference associated with the refrigerant pressure difference between the measurement point and the compressor inlet (function for ΔET to be provided by the device maker, e.g., Carrier®) as shown in.

ETc1=ET1+ΔET Equation 1

Alternatively, if suction pressure is measured, the corrected evaporating temperature is calculated using the saturated vapor pressure-temperature relationship (Tsatvap( )) for the appropriate refrigerant as shown in

ETc1=Tsatvap(SP1) Equation 2

Superheat (SH):

SH1=ST1−ETc1 Equation 3

Corrected Condensing Temperature (CTc):

If the condensing temperature is measured directly with a temperature sensor in the two-phase region of the outdoor coil, then its value is corrected for the temperature difference associated with the refrigerant pressure difference between the measurement point and the condenser outlet (function for ΔCT to be provided by device manufacturer, e.g., Carrier®) as shown in Equation 4.

CTc1=CT1+ΔCT Equation 4

Alternatively, if liquid pressure is measured, the corrected condensing temperature is calculated using the saturated liquid pressure-temperature relationship (Tsatliq( )) for the appropriate refrigerant as shown in Equation.

CTc1=Tsatliq(LP1) Equation 5

Alternatively, if discharge pressure is measured, the corrected condensing temperature is calculated by subtracting the pressure drop across the condenser coil (function for ΔP to be provided by Carrier) and then calculating the saturation temperature using the saturated liquid pressure-temperature relationship (Tsatliq( )) for the appropriate refrigerant as shown in Equation 6.

CTc1=Tsatliq(DP1−ΔP) Equation 6

Condensing Temperature Over Ambient (COA):

COA1=CTc1−OAT Equation 7

Subcooling (SC):

SC1=CTc1−LT1 Equation 8

Indoor Temperature Difference (ITD):

In this case, the appropriate equation based on the mode (cooling or not-cooling) and available indoor dry bulb temperature measurement (RAT or ZAT) are used as shown and summarized in Table 22 for the Data Configuration ID (DCID) referenced below.

TABLE 22
Data Configuration ID.

| | | Indoor | | |
|---|---|---|---|---|
| DCID | SYS_TYPE | Temperature | Indoor Humidity | Notes |
| 1 | AC (1) | RAT | RAH | Preferred |
| 2 | AC (1) | ZAT | BAH | |
| 3 | HP (2) | RAT | RAH | Preferred |
| 4 | HP (2) | ZAT | BAH | |

In cooling mode and RAT available (DCID=1 or 3).

ITD=RAT−SAT Equation 9

In cooling mode and RAT not available (DCID=2 or 4)

ITD=ZAT−SAT Equation 10

In not cooling mode and RAT available (DCID=1 or 3)

ITD=SAT−RAT Equation 11

In not cooling mode and RAT not available (DCID=2 or 4)

ITD=SAT−ZAT Equation 12

In normalized currents, normalized whole unit current (WUCn) using ScalingFactor in Equation 13 and defined in Table 31.

$$WUCn = \frac{WUC}{ScalingFactor} \qquad Equation 13$$

TABLE 31
Scaling Factor (Amps) for Whole Unit Current (WUC).

SYS_CONFIG

| | | | |
|---|---|---|---|
| 1 | 1 | 2 | 2 |

SYS_TYPE

| | 1 | 2 | 1 | 2 |
|---|---|---|---|---|
| COOL_CAP | Package AC (no | Package | Split | Split |
| (kBtu/h) | electric heat) | HP | AC | HP |
| 36 | 30 | | 30 | 30 |
| 48 | | | | |
| 60 | | | | |
| 72 | | | | |
| 90 | 60 | | | |
| 102 | 60 | | | |
| 120 | 60 | | | |
| 150 | 60 | | | |

In normalized indoor unit current (BUCn) using ScalingFactor in Equation 14 with a fixed value of 30 Amps:

$$BUCn = \frac{BUC}{ScalingFactor} \qquad Equation 14$$

The define “binned” independent variables are summarized in Table 23.

TABLE 23
Binned Independent Variables.

| | | | | | | |
|---|---|---|---|---|---|---|
| | | | | | | Not |
| | | | I-P | | | Applicable |
| ID | Symbol | Description | Units | SI Units | Type | Rule |

| | | | | |
|---|---|---|---|---|
| 3-16 | ECb | Economizer Position (binned value) | # | # |
| 3-17 | ZATb | Zone Air Temperature (binned value) | # | # |
| 3-18 | BAHb | Building Air Humidity (binned value) | # | # |
| 3-19 | RATb | Return Air Temperature (binned value) | # | # |
| 3-20 | RAHb | Return Air Humidity (binned value) | # | # |
| 3-21 | OATb | Outside Air Temperature (binned value) | # | # |
| 3-22 | OAHb | Outside Air Humidity (binned value) | # | # |

The bin structure shown in Table 28 can be used to convert the current values to binned vales (their current values can be read over, for example, a BACnet network at any time).

TABLE 28
Independent Variables - Bin Structure.

| | | | BAH, | |
|---|---|---|---|---|
| | | RAT and | RAH, and | |
| Bin ID | EC | ZAT (F) | OAH (%) | OAT (F) |
| 0 | <(−10) | <35 | <0 | <(−25) |
| 1 | −10 to 0 | 35 to 40 | 0 to 10 | −25 to −20 |
| 2 | 0 to 2 | 40 to 45 | 10 to 20 | −20 to −15 |
| 3 | 2 to 4 | 45 to 50 | 20 to 25 | −15 to −10 |
| 4 | 4 to 6 | 50 to 55 | 25 to 28 | −10 to −5 |
| 5 | 6 to 8 | 55 to 60 | 28 to 30 | −5 to 0 |
| 6 | 8 to 10 | 60 to 61 | 30 to 32 | 0 to 5 |
| 7 | 10 to 12 | 61 to 62 | 32 to 34 | 5 to 10 |
| 8 | 12 | 62 | 34 to 36 | 10 |
| 9 | 14 | 63 | 36 to 38 | 15 |
| 10 | 16 | 64 | 38 to 40 | 20 |
| 11 | 18 | 65 | 40 to 42 | 25 |
| 12 | 20 | 66 | 42 to 44 | 30 |
| 13 | 22 | 67 | 44 to 46 | 35 |
| 14 | 24 | 68 | 46 to 48 | 40 |
| 15 | 26 | 69 | 48 to 50 | 45 |
| 16 | 28 to 30 | 70 to 71 | 50 to 52 | 50 to 55 |
| 17 | 30 to 35 | 71 to 72 | 52 to 54 | 55 to 60 |
| 18 | 35 to 40 | 72 to 73 | 54 to 56 | 60 to 65 |
| 19 | 40 | 73 | 56 to 58 | 65 to 70 |
| 20 | 45 | 74 | 58 to 60 | 70 to 75 |
| 21 | 50 | 75 | 60 to 62 | 75 |
| 22 | 55 | 76 | 62 to 64 | 80 |
| 23 | 60 | 77 | 64 to 66 | 85 |
| 24 | 65 | 78 | 66 to 68 | 90 |
| 25 | 70 | 79 | 68 to 70 | 95 |
| 26 | 75 to 80 | 80 to 81 | 70 to 72 | 100 to 105 |
| 27 | 80 to 85 | 81 to 82 | 72 to 75 | 105 to 110 |
| 28 | 85 to 90 | 82 to 85 | 75 to 80 | 110 to 115 |
| 29 | 90 to 95 | 85 to 90 | 80 to 90 | 115 to 120 |
| 30 | 95 to 100 | 90 to 95 | 90 to 100 | 120 to 125 |
| 31 | >100 | >95 | >100 | >125 |

The defined “binned” dependent variables and performance indices (PIs) are shown and summarized in Table 24.

TABLE 24
Binned Dependent Variables and Performance Indices.

| | | | | | | Not |
|---|---|---|---|---|---|---|
| | | | I-P | | | Applicable |
| ID | Symbol | Description | Units | SI Units | Type | Rule |
| 3-23 | ITDb | Indoor temperature difference (binned value) | # | # | | |
| 3-24 | ETc1b | Evaporating temperature, corrected - Circuit | # | # | | |
| | | 1 (binned value) | | | | |
| 3-25 | ETc2b | Evaporating temperature, corrected - Circuit | # | # | | |
| | | 2 (binned value) | | | | |
| 3-26 | SH1b | Superheat - Circuit 1 (binned value) | # | # | | |
| 3-27 | SH2b | Superheat - Circuit 2 (binned value) | # | # | | |
| 3-28 | CTc1b | Condensing temperature - Circuit 1 (binned | # | # | | |
| | | value) | | | | |
| 3-29 | CTc2b | Condensing temperature - Circuit 2 (binned | # | # | | |
| | | value) | | | | |
| 3-30 | COA1b | Condensing temperature over ambient - | # | # | | |
| | | Circuit 1 (binned value) | | | | |
| 3-31 | COA2b | Condensing temperature over ambient - | # | # | | |
| | | Circuit 2 (binned value) | | | | |
| 3-32 | SC1b | Subcooling - Circuit 1 (binned value) | # | # | | |
| 3-33 | SC2b | Subcooling - Circuit 2 (binned value) | # | # | | |
| 3-34 | WUCnb | Whole Unit Current, normalized (binned | # | # | | |
| | | value) | | | | |
| 3-35 | BUCnb | Indoor Blower Unit Current, normalized | # | # | | |
| | | (binned value) | | | | |
| 3-36 | ST1b | Suction Temperature - Circuit 1 (binned | # | # | | |
| | | value) | | | | |
| 3-37 | ST2b | Suction Temperature - Circuit 2 (binned | # | # | | |
| | | value) | | | | |
| 3-38 | SATb | Supply Air temperature (binned value) | # | # | | |

The bin scheme shown in Table 29 can be used to convert current values to binned values (their current values can be read over, for example, the BACnet network at any time).

TABLE 29
Dependent Variables and Performance Indices - Bin Structure.

| | | | ETc1 | | COA1 | | CTc1 | | |
|---|---|---|---|---|---|---|---|---|---|
| | WUCn | | and | SH1 | and | SC1 | and | ST1 | |
| Bin | and | | ETc2 | and | COA2 | and | CTc2 | and | SAT |
| ID | BUCn | ITD (F.) | (F.) | SH2 (F.) | (F.) | SC2 (F.) | (F.) | ST2 (F.) | (F.) |
| 0 | <(−10) | <(−2) | <−12 | <2 | <−32 | <0 | <30 | <−10 | <30 |
| 1 | −10 to 0 | −2 to 0 | −12 to −2 | 2 to 4 | −32 to −22 | 1 to 2 | 30 to | −10 to −0 | 30 to |
| | | | | | | | 35 | | 35 |
| 2 | 0 to 2 | 0 to 2 | −2 to 8 | 4 to 6 | −22 to −12 | 2 to 3 | 35 to | 0 to 10 | 35 to |
| | | | | | | | 40 | | 40 |
| 3 | 2 to 4 | 2 to 4 | 8 to 13 | 6 to 8 | −12 to −7 | 3 to 4 | 40 to | 10 to | 40 to |
| | | | | | | | 45 | 15 | 45 |
| 4 | 4 to 6 | 4 to 6 | 13 to | 8 to 9 | −7 to −2 | 4 to 5 | 45 to | 15 to | 45 to |
| | | | 18 | | | | 50 | 20 | 50 |
| 5 | 6 | 6 | 18 to | 9 to 10 | −2 to 0 | 5 | 50 to | 20 to | 50 to |
| | | | 20 | | | | 55 | 25 | 52 |
| 6 | 8 | 8 | 20 to | 10 to | 0 to 2 | 6 | 55 to | 25 to | 52 to |
| | | | 22 | 11 | | | 60 | 30 | 54 |
| 7 | 10 | 10 | 22 to | 11 to | 2 to 4 | 7 | 60 to | 30 to | 54 |
| | | | 24 | 12 | | | 64 | 35 | |
| 8 | 12 | 12 | 24 to | 12 to | 4 to 6 | 8 | 64 to | 35 to | 56 |
| | | | 26 | 13 | | | 68 | 40 | |
| 9 | 14 | 14 | 26 to | 13 to | 6 to 8 | 9 | 68 to | 40 to | 58 |
| | | | 28 | 14 | | | 72 | 42 | |
| 10 | 16 | 16 | 28 to | 14 to | 8 to 10 | 10 | 72 to | 42 to | 60 |
| | | | 30 | 15 | | | 76 | 44 | |
| 11 | 18 | 18 | 30 to | 15 to | 10 to | 11 | 76 to | 44 to | 62 |
| | | | 32 | 16 | 12 | | 80 | 46 | |
| 12 | 20 | 20 to | 32 to | 16 to | 12 to | 12 | 80 to | 46 to | 64 |
| | | 22 | 34 | 17 | 14 | | 84 | 48 | |
| 13 | 22 | 22 | 34 to | 17 to | 14 to | 13 | 84 | 48 to | 66 |
| | | | 36 | 18 | 16 | | | 50 | |
| 14 | 24 | 24 | 36 to | 18 to | 16 to | 14 | 88 | 50 to | 68 |
| | | | 38 | 19 | 18 | | | 52 | |
| 15 | 26 | 26 | 38 to | 19 to | 18 to | 15 | 92 | 52 to | 70 |
| | | | 40 | 20 | 20 | | | 54 | |
| 16 | 28 to | 28 | 40 to | 20 to | 20 to | 16 | 96 | 54 to | 72 |
| | 30 | | 42 | 21 | 22 | | | 56 | |
| 17 | 30 to | 30 | 42 to | 21 to | 22 to | 17 | 100 | 56 to | 74 to |
| | 35 | | 44 | 22 | 24 | | | 58 | 76 |
| 18 | 35 | 32 | 44 to | 22 to | 24 to | 18 | 104 | 58 to | 76 to |
| | | | 46 | 23 | 26 | | | 60 | 78 |
| 19 | 40 | 34 | 46 to | 23 to | 26 to | 19 | 108 | 60 to | 78 to |
| | | | 48 | 24 | 28 | | | 62 | 80 |
| 20 | 45 | 36 | 48 to | 24 to | 28 to | 20 | 112 | 62 to | 80 to |
| | | | 50 | 26 | 30 | | | 64 | 85 |
| 21 | 50 | 38 to | 50 to | 26 to | 30 to | 21 | 116 | 64 to | 85 to |
| | | 40 | 52 | 28 | 32 | | | 66 | 90 |
| 22 | 55 | 40 to | 52 to | 28 to | 32 to | 22 | 120 | 66 to | 90 to |
| | | 44 | 54 | 30 | 34 | | | 68 | 100 |
| 23 | 60 | 44 | 54 to | 30 to | 34 to | 23 | 124 | 68 to | 100 to |
| | | | 56 | 32 | 36 | | | 70 | 105 |
| 24 | 65 | 48 | 56 to | 32 to | 36 to | 24 to | 128 | 70 to | 105 to |
| | | | 58 | 34 | 38 | 25 | | 75 | 110 |
| 25 | 70 | 52 | 58 to | 34 to | 38 to | 25 to | 132 | 75 to | 110 |
| | | | 60 | 36 | 40 | 26 | | 80 | |
| 26 | 75 | 56 | 60 to | 36 to | 40 to | 26 to | 136 to | 80 to | 115 |
| | | | 62 | 38 | 42 | 28 | 140 | 85 | |
| 27 | 80 | 60 | 62 to | 38 to | 42 to | 28 to | 140 to | 85 to | 120 |
| | | | 67 | 41 | 47 | 30 | 144 | 90 | |
| 28 | 85 | 64 | 67 to | 41 to | 47 to | 30 to | 144 to | 90 to | 125 |
| | | | 72 | 44 | 52 | 35 | 148 | 95 | |
| 29 | 90 to | 68 to | 72 to | 44 to | 52 to | 35 to | 148 to | 95 to | 130 to |
| | 95 | 72 | 82 | 47 | 62 | 40 | 152 | 100 | 135 |
| 30 | 95 to | 72 to | 82 to | 47 to | 62 to | 40 to | 152 to | 100 to | 135 to |
| | 100 | 74 | 92 | 50 | 72 | 45 | 156 | 105 | 140 |
| 31 | >100 | >74 | >92 | >50 | >72 | >45 | >156 | >105 | >140 |

Next, the system and method will calculate, store and report performance history. Table 25 defines a configuration of the history data storage tables.

TABLE 25
History Configuration Parameters - Read/Write over the BACnet network.

| ID | Symbol | Description | Units | Default |
|---|---|---|---|---|
| 3-39 | NDAYS | Number of full days in the “accumulation period” | day | 7 |
| 3-40 | NBINS_ACTIVE | Number of bins retained for active record (current | — | 500 |
| | | accumulation period) | | |
| 3-41 | NBINS_HIST | Number of bins retained for history records | — | 50 |
| 3-42 | NPERIODS | Number of periods to retain history records | — | 10 |
| 3-43 | PERIOD_PTR | Pointer to active period - valid values are 0 for the | — | 1 |
| | | active accumulation period and 1 to | | |
| | | NPERIODS_HIST for the history periods | | |
| 3-44 | BIN_PTR | Pointer to the current bin - valid values are 1 to | — | 1 |
| | | NBINS_ACTIVE for the active accumulation | | |
| | | period (PERIOD_PTR = 0) and 1 to NBINS_HIST | | |
| | | for the history periods (PERIOD_PTR > 0) | | |

The “accumulation period” noted in the table above is defined as a period of duration NDAYS days (whole days—no fractional values) starting at exactly the next midnight after the software is started or “hard reset”. After a “soft reset” or power cycling, the beginning of the “accumulation period” does not change. The “history periods” noted in the table above are defined as up to NPERIODS periods in the past. A history period contains NBINS_HIST bins. Each bin contains one copy of each value contained in Table 27. Initialize START_TIME for all history periods to 0, when the software is first started or has a “hard reset”.

The current “accumulation period” contains NBINS_ACTIVE number of bins. Each bin contains one copy of each value contained in Table 27. After the software is started, “hard reset” or when a new “accumulation period” starts, all MIN_TOT and MIN_SS values are initialized to 0, indicating no operating time in this bin.

TABLE 27
Performance History Period Data.

| ID | Parameter | Bits | Specification | Bin Structure | Variable Type |
|---|---|---|---|---|---|
| 3-45 | DCID | 2 | Data Configuration ID | | |
| 3-46 | START_TIME | 16 | Days (with integer precision) | | Time Stamp |
| | | | since 1/1/1900 when the | | |
| | | | “period” starts | | |
| 3-47 | STOP_TIME | 16 | Days (with integer precision) | | Time Stamp |
| | | | since 1/1/1900 when the | | |
| | | | “period” ends | | |

The values DCID and START_TIME defined in the table above are filled in appropriately when the “accumulation period” is initialized. There is one copy of the variables in the table for each “period”. A “period” is defined as the “accumulation period” or any one of NPERIOD “history periods” stored in memory.

As the software is executed, all the Independent and Dependent/Performance Index values in Table 27 are evaluated.

TABLE 27
Performance History Bin Data.

| ID | Parameter | Bits | Specification | Bin Structure | Variable Type |
|---|---|---|---|---|---|
| 3-48 | DOS | 6 | Digital Output Status | | Independent |
| | | | [SF(1), CS1(1), CS2(1), H1(1), | | |
| | | | H2(1), PEF(1)] for DCID = 1 or 2 | | |
| | | | (AC) | | |
| | | | or | | |
| | | | [SF(1), CS1(1), CS2(1), RV(1), | | |
| | | | EH(1), PEF(1)] for DCID = 3 or 5 | | |
| | | | (HP) | | |
| 3-49 | EC | 5 | Economizer Position | Per Table 28 | Independent |
| 3-50 | OAT | 5 | OAT | Per Table 28 | Independent |
| 3-51 | OAH | 5 | OAH | Per Table 28 | Independent |
| 3-52 | RAT or | 5 | Indoor Drybulb Temperature | Per Table 28 | Independent |
| | ZAT | | Measurement | | |
| | | | RAT for DCID = 1 or 3 | | |
| | | | Or | | |
| | | | ZAT for DCID = 2 or 5 | | |
| 3-53 | RAH or | 5 | Indoor Relative Humidity | Per Table 28 | Independent |
| | BAH | | Measurement | | |
| | | | RAH for DCID = 1 or 3 | | |
| | | | Or | | |
| | | | BAH for DCID = 2 or 5 | | |
| 3-54 | ITD or | 5 | ITD per Section 0 definition or | Per Table 29 | Dependent or Performance |
| | SAT | | (SAT if no RAT or ZAT) | | Index |
| 3-55 | WUCn | 5 | | Per Table 29 | Dependent or Performance |
| | | | | | Index |
| 3-56 | BUCn | 5 | | Per Table 29 | Dependent or Performance |
| | | | | | Index |
| 3-57 | ETc1 | 5 | | Per Table 29 | Dependent or Performance |
| | | | | | Index |
| 3-58 | SH1 or | 5 | SH1 or (ST1 if no ET1) | Per Table 29 | Dependent or Performance |
| | ST1 | | | | Index |
| 3-59 | COA1 or | 5 | COA1 or (CT1 if no OAT) | Per Table 29 | Dependent or Performance |
| | CTc1 | | | | Index |
| 3-60 | SC1 | 5 | | Per Table 29 | Dependent or Performance |
| | | | | | Index |
| 3-61 | ETc2 | 5 | | Per Table 29 | Dependent or Performance |
| | | | | | Index |
| 3-62 | SH2 or | 5 | SH2 or (ST2 if no ET1) | Per Table 29 | Dependent or Performance |
| | ST2 | | | | Index |
| 3-63 | COA2 or | 5 | COA2 or (CT2 if no OAT) | Per Table 29 | Dependent or Performance |
| | CTc2 | | | | Index |
| 3-64 | SC2 | 5 | | Per Table 29 | Dependent or Performance |
| | | | | | Index |
| 3-65 | MIN_TOT | 16 | Minutes of total operation in this bin | | Time Accumulator |
| | | | (with 0.1 precision) | | |
| 3-66 | MIN_SS | 16 | Minutes of steady-state operation in | | Time Accumulator |
| | | | this bin (with 0.1 precision) | | |

The “current bin” is defined by all of the above variables. If any one of them changes, then the “current bin” changes. The time spent in the “current bin” since the last change (in minutes) is defined as the “accumulated time”. The time spent in the “current bin” since the last change is defined with the “Steady-State Flag” (SS_FLAG) TRUE (1) (in minutes) as the “accumulated steady-state time”. When the “current bin” changes, the program searches down the list of active bins looking for all the same bin values. If this is found before reaching the end (identified by MIN_TOT=0), then the “accumulated time” is added to MIN_TOT and the “accumulated steady-state time” is added to MIN_SS. If the end of the list is reach, then the new bin value is added to the end, the MIN_TOT is set to “accumulated time” and the MIN_SS is set to “accumulated steady-state time”. If the list fills up (there are only NBINS_ACTIVE defined), then no new bins are added.

If DCID, NDAYS or NBINS_ACTIVE change, then the “accumulation period” is reset, but the “history periods” are not changed.

To read out the “accumulation period” history values, the PERIOD_PTR is set to 0, and the BIN_PTR is set to the desired bin (1 to NBINS_ACTIVE) and the desired bin value is read.

When the “accumulation period” rolls over at midnight every NDAYS, the following is executed: the STOP_TIME is set to a last day of the “accumulation period”; the “Period Data” identified in Table 26 is copied to the history period with the minimum START_TIME (oldest record), and if there are more than one period with the minimum START_TIME, the one with the smallest PERIOD_PTR is used; then NBINS_HIST bins is copied from the NBINS_ACTIVE bins in the “accumulation period” to the same older history period. Thus, NBINS_HIST should be less than NBINS_ACTIVE. The NBINS_HIST bins with the largest values of MIN_SS is copied and inserted in the order by MIN_SS with the largest value first (BIN_PTR=1).

To read out the “history period” values, PERIOD_PTR is set to the desire period (1 to NPERIODS), BIN_PTR is set to the desired bin (1 to NBINS_HIST) and the desired bin value is read. If NPERIODS or NBINS_HIST changes, then the “accumulation period” and all the “history periods” are reset as if there was a “hard reset.”

Upon request from the BACnet network, the current values of all data points collected by or through the ALC controller or status variable know to the ALC controller will be provided. The general approach is described as follows.

Program Startup and Reset:

When the controller is first started up or has a “hard reset”, the following sequence will occur. The Configuration Parameters (see Table 32) and the System Configuration Values (see Table 35) are set to the default values specified in the these tables.

TABLE 32
Configuration Parameters - Read/Write over the BACnet network.

| ID | Symbol | Description | Units | Default |
|---|---|---|---|---|
| 1-1 | UNITS | Measurement Units | | 1 |
| | | (1 = I-P, 2 = SI) | | |

TABLE 35
Module System Configuration Variable Data Points - Read over
the BACnet network.

| | | | | | | Default |
|---|---|---|---|---|---|---|
| ID | Symbol | Description | I-P Units | SI Units | Type | Value |
| 1-38 | SYS_TYPE | System Type (1 = AC, 2 = HP) | # | | SCV | 1 |
| 1-39 | SYS_CONFIG | System Configuration (1 = Package, | # | | SCV | 1 |
| | | 2 = Split) | | | | |
| 1-40 | REF | Refrigerant (1 = R22, 2 = R410A) | # | | SCV | 2 |
| 1-41 | N_CIRC | Number of refrigeration cycle | | | SCV | −1 |
| | | circuits (0, 1, or 2) | | | | |
| 1-42 | IED | Indoor Expansion Device (1 = TxV, | # | | SCV | 1 |
| | | 2 = FO/Cap, 3 = ExV) assume same | | | | |
| | | for all circuits | | | | |
| 1-43 | OED | Outdoor Expansion Device (1 = TxV, | # | | SCV | 1 |
| | | 2 = FO/Cap, 3 = ExV) - assume same | | | | |
| | | for all circuits | | | | |
| 1-44 | RV_TYPE | Reversing Valve Type (1 = Energize | # | | SCV | −2 |
| | | Cool, 2 = Energize heat) | | | | |
| 1-45 | VOLTAGE | Input power voltage (1 = 120, | # | | SCV | −1 |
| | | 2 = 208/240, 3 = 460, 4 = 575) | | | | |
| 1-46 | PHASE | Input power phase (1 or 3) | | | SCV | −1 |
| 1-47 | HEAT_OPT | Heating Option for A/C units | # | | SCV | 2 |
| | | (0 = Not applicable, 1 = No heat, | | | | |
| | | 2 = One stage gas furnace, 3 = Two | | | | |
| | | stage gas furnace, 4 = One stage | | | | |
| | | electric heat, 5 = two stage electric | | | | |
| | | heat) | | | | |
| 1-48 | FAN_CONFIG | Fan configuration (1 = Draw through, | | | | |
| | | SAT before fan, 2 = Draw through, | | | | |
| | | SAT after fan, 3 = Draw through, | | | | |
| | | SAT after heater, 4 = Blow through, | | | | |
| | | SAT before heater, 5 = Blow | | | | |
| | | through, SAT after heater) | | | | |
| 1-49 | PERF_MOD | Normal performance model ID | # | | SCV | −1 |
| 1-50 | OAD_TYPE | Outdoor air damper type | # | | SCV | −1 |
| 1-51 | LOWAMB_INST | Low Ambient Installed? (0 = No, | # | | SCV | 1 |
| | | 1 = Yes) | | | | |
| 1-52 | ECONO_INST | Economizer Installed? (0 = No, | # | | SCV | 1 |
| | | 1 = Yes) | | | | |
| 1-53 | PEF_INST | Power Exhaust Fan Installed? | # | | SCV | 1 |
| | | (0 = No, 1 = Yes) | | | | |
| 1-54 | COOL_CAP | Rated cooling capacity | kBtu/h | kW | SCV | −1 |
| 1-55 | COOL_SEER | Rated cooling efficiency (SEER) | Btu/Wh | Btu/Wh | SCV | −1 |
| 1-56 | COOL_EER | Rated cooling efficiency (EER) | Btu/Wh | Btu/Wh | SCV | −1 |
| 1-57 | HEAT_CAP | Rated heating capacity | kBtu/h | kW | SCV | −1 |
| 1-58 | HEAT_COP | Rated heating efficiency (COP) | — | — | SCV | −1 |
| 1-59 | SH_NOM | Nominal superheat value | F. | C. | SCV | −2 |
| 1-60 | SC_NOM | Nominal subcooling value | F. | C. | SCV | −1 |
| 1-61 | OUT_MOD_ID | Outdoor/Package unit - model | # | | SCV | −1 |
| | | unique ID | | | | |
| 1-62 | OUT_SER_ID | Outdoor/Package unit - serial | # | | SCV | −1 |
| | | unique ID | | | | |
| 1-63 | IN_MOD_ID | Indoor unit - model unique ID | # | | SCV | −1 |
| 1-64 | IN_SER_ID | Indoor unit - serial unique ID | # | | SCV | −1 |

All other Data Points (see Table 34) will be set to their default value depending on their type.

TABLE 34
Module General Data Points - Read over the BACnet network.

| | | | | | | Not | | | | |
|---|---|---|---|---|---|---|---|---|---|---|
| | | | I-P | | | Applicable | Low | | High | |
| ID | Symbol | Description | Units | SI Units | Type | Rule | Limit | | Limit | |
| 1-2 | LST | Last Sample Time | days¹ | days | SYS | | | | | |
| 1-3 | WUC | Whole Unit Current | Amps | Amps | DSV | | −100 | A | +1000 | A |
| 1-4 | BUC | Indoor Blower Unit | Amps | Amps | DSV | | −100 | A | +1000 | A |
| | | Current | | | | | | | | |
| 1-5 | SAT | Supply Air | F. | C. | DSV | | −100 | F. | +300 | F. |
| | | Temperature | | | | | | | | |
| 1-6 | ET1 | Evaporating | F. | C. | DSV | | −100 | F. | +300 | F. |
| | | temperature - | | | | | | | | |
| | | Circuit 1 | | | | | | | | |
| 1-7 | SP1 | Suction Pressure - | psig | bar | NOT | | | | | |
| | | Circuit 1 | | | USED | | | | | |
| 1-8 | ST1 | Suction | F. | C. | DSV | | −100 | F. | +300 | F. |
| | | Temperature - | | | | | | | | |
| | | Circuit 1 | | | | | | | | |
| 1-9 | CT1 | Condensing | F. | C. | DSV | | −100 | F. | +300 | F. |
| | | Temperature - | | | | | | | | |
| | | Circuit 1 | | | | | | | | |
| 1-10 | LP1 | Liquid Pressure - | psig | bar | NOT | | | | | |
| | | Circuit 1 | | | USED | | | | | |
| 1-11 | DP1 | Discharge Pressure - | psig | bar | NOT | | | | | |
| | | Circuit 1 | | | USED | | | | | |
| 1-12 | LT1 | Liquid Temperature - | F. | C. | DSV | | −100 | F. | +300 | F. |
| | | Circuit 1 | | | | | | | | |
| 1-13 | ET2 | Evaporating | F. | C. | DSV | Rule A | −100 | F. | +300 | F. |
| | | temperature - | | | | | | | | |
| | | Circuit 2 | | | | | | | | |
| 1-14 | SP2 | Suction Pressure - | psig | bar | NOT | | | | | |
| | | Circuit 2 | | | USED | | | | | |
| 1-15 | ST2 | Suction | F. | C. | DSV | Rule A | −100 | F. | +300 | F. |
| | | Temperature - | | | | | | | | |
| | | Circuit 2 | | | | | | | | |
| 1-16 | CT2 | Condensing | F. | C. | DSV | Rule A | −100 | F. | +300 | F. |
| | | Temperature - | | | | | | | | |
| | | Circuit 2 | | | | | | | | |
| 1-17 | LP2 | Liquid Pressure - | psig | bar | NOT | | | | | |
| | | Circuit 2 | | | USED | | | | | |
| 1-18 | DP2 | Discharge Pressure - | psig | bar | NOT | | | | | |
| | | Circuit 2 | | | USED | | | | | |
| 1-19 | LT2 | Liquid Temperature - | F. | C. | DSV | Rule A | −100 | F. | +300 | F. |
| | | Circuit 2 | | | | | | | | |
| 1-20 | SF | Supply Fan Control | Digital: | Digital: 0 | DOS | | | | | |
| | | Output Status | 0 or 1 | or 1 | | | | | | |
| 1-21 | CS1 | Compressor 1 | Digital: | Digital: 0 | DOS | | | | | |
| | | Control Output | 0 or 1 | or 1 | | | | | | |
| | | Status | | | | | | | | |
| 1-22 | CS2 | Compressor 2 | Digital: | Digital: 0 | DOS | Rule A | | | | |
| | | Control Output | 0 or 1 | or 1 | | | | | | |
| | | Status | | | | | | | | |
| 1-23 | H1 | Heat 1 Control | Digital: | Digital: 0 | DOS | Rule D | | | | |
| | | Output Status | 0 or 1 | or 1 | | | | | | |
| 1-24 | RV | Reversing Valve | Digital: | Digital: 0 | DOS | Rule B | | | | |
| | | Control Output | 0 or 1 | or 1 | | | | | | |
| | | Status | | | | | | | | |
| 1-25 | H2 | Heat 2 Control | Digital: | Digital: 0 | DOS | Rule E | | | | |
| | | Output Status | 0 or 1 | or 1 | | | | | | |
| 1-26 | EH | Emergency Heat | Digital: | Digital: 0 | DOS | Rule B | | | | |
| | | Control Output | 0 or 1 | or 1 | | | | | | |
| | | Status | | | | | | | | |
| 1-27 | PEF | Power Exhaust Fan | Digital: | Digital: 0 | DOS | Rule F | | | | |
| | | Control Output | 0 or 1 | or 1 | | | | | | |
| | | Status | | | | | | | | |
| 1-28 | EC. | Economizer | (0 to | (0 to 100) | AOS | Rule C | | | | |
| | | Position | 100) | | | | | | | |
| 1-29 | CLMC | Active Cooling | F. | C. | CSV | | | | | |
| | | Setpoint | | | | | | | | |
| 1-30 | HTMC | Active Heating | F. | C. | CSV | | | | | |
| | | Setpoint | | | | | | | | |
| 1-31 | ZAT | Zone Air | F. | C. | NSV | | −100 | F. | +300 | F. |
| | | Temperature | | | | | | | | |
| 1-32 | BAH | Building Air | RH (0 to | RH (0 to | NSV | | −20 | | +120 | |
| | | Humidity | 100) | 100) | | | | | | |
| 1-33 | RAT | Return Air | F. | C. | NOT | | −100 | F. | +300 | F. |
| | | Temperature | | | USED | | | | | |
| 1-34 | RAH | Return Air | F. | C. | NOT | | −20 | | +120 | |
| | | Humidity | | | USED | | | | | |
| 1-35 | OAT | Outside Air | F. | C. | NSV | | −100 | F. | +300 | F. |
| | | Temperature | | | | | | | | |
| 1-36 | OAH | Outside Air | RH (0 to | RH (0 to | NSV | | −20 | | +120 | |
| | | Humidity | 100) | 100) | | | | | | |
| 1-37 | BAC | Building Air CO2 | PPM | PPM | NSV | | 0 | | 5000 | |
| | | Concentration | | | | | | | | |

¹Measured from Midnight Jan. 1, 1900

Program Main Loop:

When the power cycles on the controller, it has a “soft reset” or any of the Configuration Parameters (see Table 32) or System Configuration Values (see Table 35) change, then the following sequence will occur.

First, the Configuration Parameters (see Table 32) and the System Configuration Values (see Table 35) are not changed. All other Data Points (see Table 34) will be set to their default value depending on their type. For all values in Table 32, Table 34 or Table 35, a prompt reply is provided when any of these values are read over the BACnet network. Any of the values are accessible as read-only inputs from the other internal software modules. When the values in Table 32 or Table 34 are changed (e.g. via a BACnet message), the new values are updated in non-volatile memory and the reset sequence described in section is executed.

For all Network sensor values (Type: NSV), the values should be current to within one minute of the time they were requested over the BACnet network. For all direct sensor values (Type: DSV), the values are updated all within 5 seconds of each other and the “Last Sample Time” is updated with the timestamp when the updated values were written to the output registers. This is followed by testing for shorted and open sensor wiring and then applying a status code if appropriate. For all analog values (Types: DSV, NSV, PI), if not shorted or open (if applicable), the values are tested against high and low limit values provided in Table 34 and a status code is applied if appropriate. A precision of 0.1 (one place to the right of the decimal point) is used, unless otherwise specified.

Configuration Parameters: refer to Table 32 for the module configuration parameters.

Data Point Types: Data Point Types are as follows and as summarized in Table 33.

TABLE 33
Data Point Types.

| | | | | | | | | Default | |
|---|---|---|---|---|---|---|---|---|---|
| | | | | Below | Above | | | Value | Default |
| | | Not | Not | Low | High | Sensor | Sensor | when | Value |
| | | Applicable | Available | Limit | Limit | Short | Open | “Not | when |
| Point Type | Abbrev. | Value | Value | Value | Value | Value² | Value³ | Applicable” | “Applicable” |
| Analog | AOS | −32,000 | −31,900 | | | | | −32,000 | −31,900 |
| Output Status | | | | | | | | | |
| Control | CSV | −32,000 | −31,900 | | | | | −32,000 | −31,900 |
| Status | | | | | | | | | |
| Variable | | | | | | | | | |
| Digital | DOS | 2 | 3 | | | | | 2 | 3 |
| Output Status | | | | | | | | | |
| Direct Sensor | DSV | −32,000 | −31,900 | −31,600 | −31,500 | −31,800 | −31,700 | −32,000 | −31,900 |
| Value | | | | | | | | | |
| Network | NSV | −32,000 | −31,900 | −31,600 | −31,500 | | | −32,000 | −31,900 |
| Sensor Value | | | | | | | | | |
| Performance | PI | −32,000 | −31,900 | | | | | −32,000 | −31,900 |
| Index | | | | | | | | | |
| System | SCV | −2 | −1 | | | | | −2 | Refer to |
| Configuration | | | | | | | | | Table |
| Value | | | | | | | | | 35 |
| System Value | SYS | | −31,900 | | | | | | −31,900 |

²Rules defined by Carrier
³Rules defined by Carrier

Where, AOS (Analog Output Status); CVS (Control Status Variable); DOS (Digital Output Status); DSV (Direct Sensor Value; i.e., sensor values connected directly to the controller); NSV (Network Sensor Value; i.e., sensor values communicated to the controller over a communication network); PI (Performance Index; i.e., calculated performance indices calculated by the controller); SCV (System Configuration Value; i.e., static unit properties); SYS (System Values); Status Code (i.e., a status code will be

recorded in lieu of a data “value” for the following conditions; the status code value is defined in Table 33 and rules are indicated in Table 34.

Moreover, where, Not Applicable (i.e., the parameter is not applicable based on the system configuration rules indicated above and Table 34; e.g., ET2 is not applicable for a single circuit AC system). If Not Available, the parameter should be available but is not because of a communication or related problem. This status applies to all NSV point types. Below low limit: value is less than low limit defined in Table 34; Above high limit: value is higher than high limit defined in Table 34. Short: sensor does not have a valid value because of short circuit problem. Open: sensor does not have a valid value because of open circuit problem. Parameter status rules (referenced in Table 34).

Rule A: N_CIRC<2

Rule B: SYS_TYPE=1

Rule C: ECONO_INST=0

Rule D: SYS_TYPE=HP or (SYS_TYPE=1 and HEAT_OPTION=1)

Rule E: SYS_TYPE=HP or (SYS_TYPE=1 and HEAT_OPTION=(1 or 3 or 4))

Rule F: PEF_INST=0

Data Points: module data points are identified in Table 34 and Table 35.

For the parameters discussed above, Table 30 shows the bin structure mapping for SI units.

TABLE 30
Bin Structure Mapping for SI Units.

| Parameters | I-P Units | SI Units | Bin Range Conversion |
|---|---|---|---|
| ZAT, RAT, OAT, ETc1, ETc2 | F | C | $SI = \frac{5}{9} ( IP - 32 )$ |
| ITD, SH1, SH2, COA1, COA2, SC1, SC2 | F | C | $SI = \frac{5}{9} ( IP )$ |

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by any appended claims and the applicable rules of law.

We claim:

1. A method for providing system data for evaluating a steady-state performance of a system, the method comprising:
providing at least one sensor in an operating heating, ventilation, air conditioning or refrigeration system, the system having at least one cycle;
sampling real-time data at a predefined frequency using the at least one sensor;
computing average values using some of the real-time data for a predefined time interval;
writing to a memory storage device one or more parameters of the system cycle, one or more computed average values, one or more E/C performance parameters, and one or more refrigeration parameters according to a pre-determined bin structure as a first data set; and
providing all or a portion of the data set over a communications network for evaluating the performance and increasing the efficiency of the system.

2. The method of claim 1, further comprising the steps of:
calculating the one or more parameters using the real-time data or the average values;
calculating the one or more E/C performance parameters; and
calculating the one or more refrigeration parameters.

3. The method of claim 1, further comprising the step of storing the real-time data in a temporary storage device.

4. The method of claim 3, further comprising the step of clearing the data in the temporary storage device.

5. The method of claim 1, further comprising the step of identifying start and end cycles.

6. The method of claim 1, further comprising the step of determining a data bin structure for the average values and the calculated cycle parameters.

7. The method of claim 1, further comprising the step of determining a E/C data bin structure.

8. The method of claim 1, further comprising the step of determining a refrigeration data bin structure.

9. The method of claim 1, wherein the system is a refrigerant-based heating and cooling device comprising a compressor and a fan.

10. The method of claim 1, wherein the calculated cycle parameter is one of an average temperature, pressure, or status.

11. The method of claim 1, wherein the E/C performance parameter is one of a temperature, pressure, or status.

12. The method of claim 1, wherein the refrigeration parameter is one of a temperature, pressure, or status.

13. An apparatus for evaluating the performance and efficiency of a steady-state system by providing information over a communications network, comprising:
at least one sensor for providing an output corresponding to at least one measurable operating parameter;
a signal conditioning and converter circuit for processing the output;
a microprocessor for assigning at least some of the data into at least one pre-determined bin, wherein the bin is used for minimizing the amount of memory space for storing the output in a memory device; and
a communications network for transmitting the bin information for subsequent evaluation.

14. The apparatus of claim 13, further comprising a communications device for retrieving the output or bin information.

15. The apparatus of claim 13, wherein the signal conditioning and converter circuit filters out transient data to reduced the data set to one consisting of quasi-steady data.

16. The apparatus of claim 13, wherein the bin structure is pre-defined based on ranges of each of the at least one operating parameter.

17. The apparatus of claim 13, wherein the bin structure comprising at least one bin identification associated with one or more of the operating parameters.

18. The apparatus of claim 13, wherein at least some of the output is stored as read-only values and transmitted over the communications network.

19. The apparatus of claim 18, wherein the assigned bin or the read-only values are transmitted by a BACnet communications network.

20. The apparatus of claim 13, wherein the communications network is a BACnet network.

21. The apparatus of claim 13, wherein the at least one measurable operating parameter is one of temperature, pressure, or status.
